(19) United States
(12) Patent Application Publication
(10) Pub. No.: US 2011/0007229 A1
(43) Pub. Date: Jan. 13, 2011

(54) LIGHTING DEVICE, DISPLAY DEVICE AND TELEVISION RECEIVER

(75) Inventor: Yoshiki Takata, Osaka-shi (JP)

Correspondence Address: SHARP KABUSHIKI KAISHA;C/O KEATING & BENNETT, LLP, 1800 Alexander Bell Drive, SUITE 200, Reston, VA, 20191, US

(73) Assignee: SHARP KABUSHIKI KAISHA, Osaka-shi, Osaka (JP)

(21) Appl. No.: 12/919,270

(22) PCT Filed: Feb. 2, 2009
(86) PCT No.: PCT/JP2009/051730

§ 371 Date: Aug. 25, 2010

(30) Foreign Application Priority Data
Feb. 27, 2008 (JP) 2008-046669

(51) Int. Cl. H04N 3/14; H05B 37/02; G02F 1/1337

(52) U.S. Cl. 348/790; 315/291; 315/294; 349/61; 348/E05.133

(57) ABSTRACT

A lighting device of the present invention includes a light source 17, a power source 170 configured to supply driving power to the light source, and a relay terminal 152 configured to electrically connect the light source 17 and the power source 170. The light source 17 includes an electrical terminal 136 configured to receive the supplied driving power. The relay terminal 152 includes a placing surface 153a on which the electrical terminal 136 is placed, and the driving power can be supplied to the light source 17 via the placing surface 153a on which the electrical terminal 136 is placed. The urging member 19 is provided independently from the relay terminal 152 so as to urge the light source 17 toward the placing surface 153a of the relay terminal 152.

### TECHNICAL FIELD

The present invention relates to a lighting device, a display device and a television receiver.

### BACKGROUND ART

In a display device using a non-light emitting optical component such as a liquid crystal display device, a backlight device is provided behind a display panel such as a liquid crystal display panel for illuminating the display panel (see Patent Document 1 as an example).
Patent Document 1: JP-A-2006-351527

### Problem to be Solved by the Invention

The backlight device disclosed in the above Patent Document 1 includes a receiving container, a first side mold, a printed circuit board and lamps. The first side mold is provided on each side of the receiving container. The printed circuit board is fixed to the first side mold and provided with a plurality of conductive clips and a power supply line assembly for transmitting a lamp driving electric power. The lamps are combined with the conductive clips to generate light upon receiving the lamp driving electric power.

The above-described backlight device has a configuration in which the lamps are combined with and fixed by the clips. Therefore, the clips are easy to be deformed when the lamps are fitted to the clips, and the deformation of the clips may cause unreliable connection and fixing of the lamps and the lamps may not be lit. An independent reinforcing configuration is required to prevent such deformation, and this increases cost or size of the device. Especially, if the device is provided with the reinforcing configuration in its thickness direction, the device is failed to be made thinner, and if the device is provided with the reinforcing configuration in its width direction, the device has only a small variety of layouts (arrangement) of the lamps.

### DISCLOSURE OF THE PRESENT INVENTION

The present invention was made in view of the foregoing circumstances, and an object thereof is to provide a lighting device that contributes to a cost reduction and is reduced in size. Another object of the present invention is to provide a display device having such a lighting device and a television receiver having such a display device.

### Means for Solving the Problem

To solve the above problem, a lighting device of the present invention includes a light source, a power source configured to supply driving power to the light source, and a relay terminal configured to electrically connect the light source and the power source. The light source includes an electrical terminal configured to receive the supplied driving power. The relay terminal has a placing surface on which the electrical terminal is placed, and the driving power is supplied to the light source via the placing surface on which the electrical terminal is placed. An urging member is provided independently from the relay terminal so as to urge the light source toward the placing surface of the relay terminal.

According to such a lighting device, the driving power is supplied to the light source via the placing surface on which the electrical terminal is placed, and the urging member urging the light source toward the placing surface is provided independently from the relay terminal. This greatly simplifies the configuration of the relay terminal and reliably applies conductivity to the light source. Since the urging member is provided independently from the relay terminal, the following advantages are obtained. The relay terminal is simply configured to have the placing surface for receiving the electrical terminal, and therefore, a configuration for holding or fixing the light source with a holding member such as a clip or the like is not necessary. This simplifies the configuration. Specifically, examples of the relay terminal include a terminal formed in a chip or a rectangular shape having only the placing surface or a terminal formed in a dish or a bowl only for receiving the lower portion of the light source and the like.

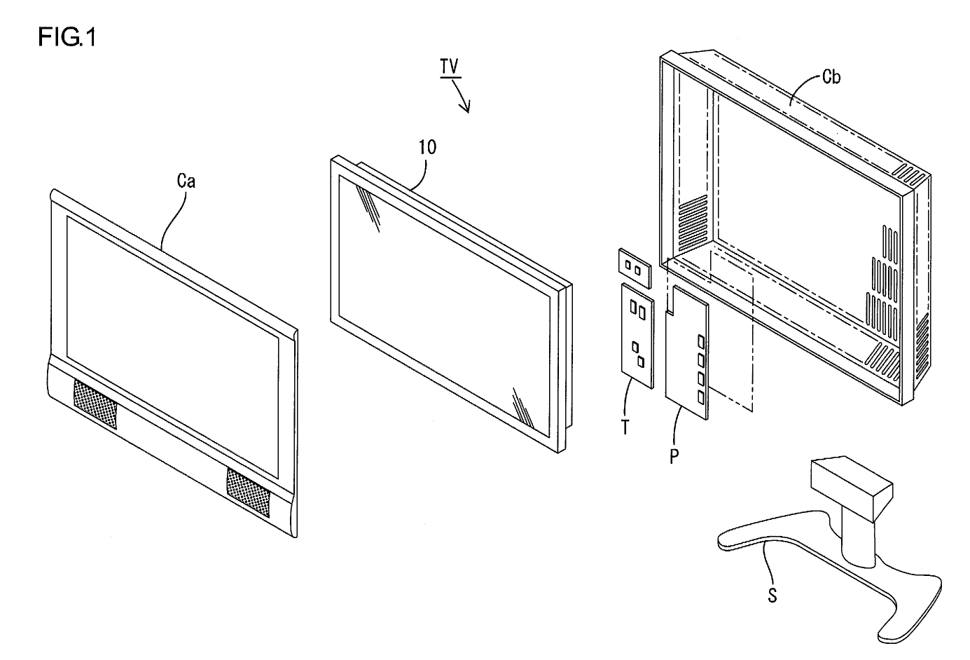

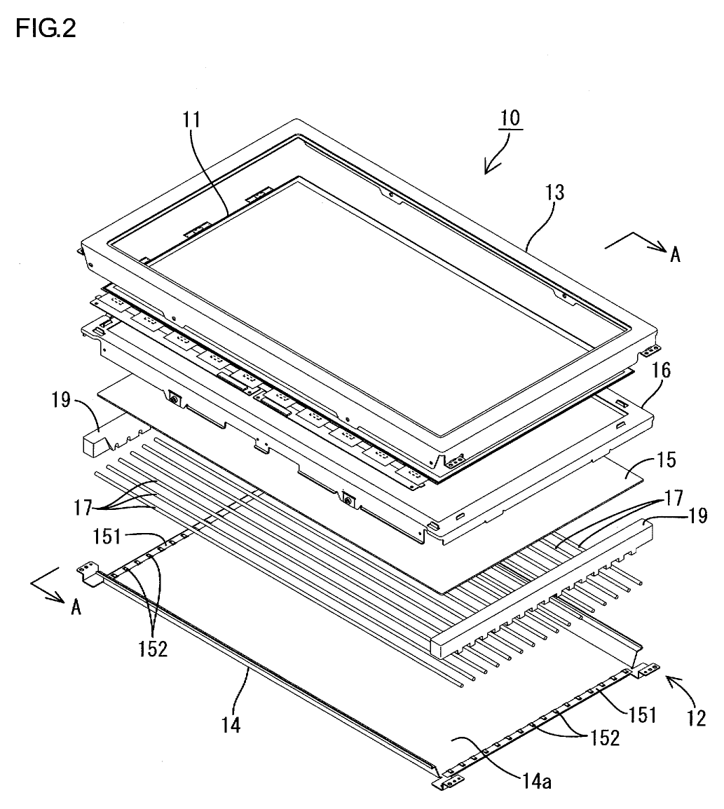

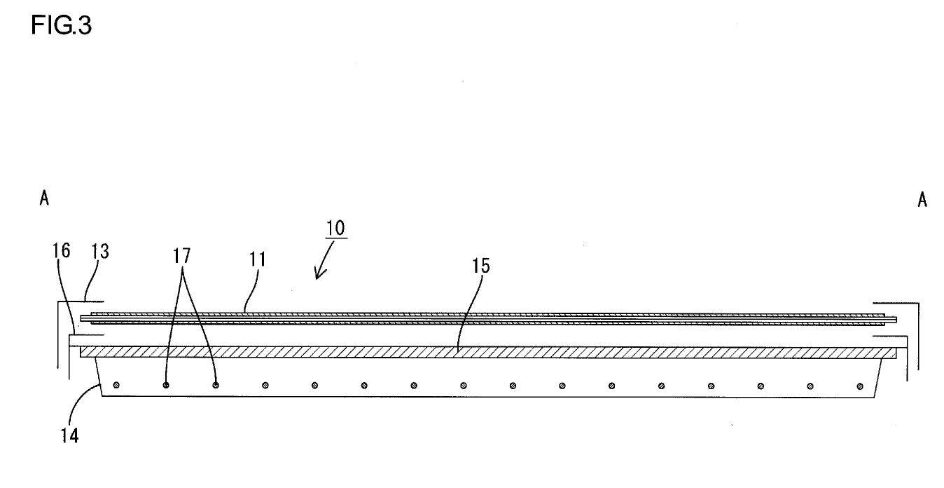

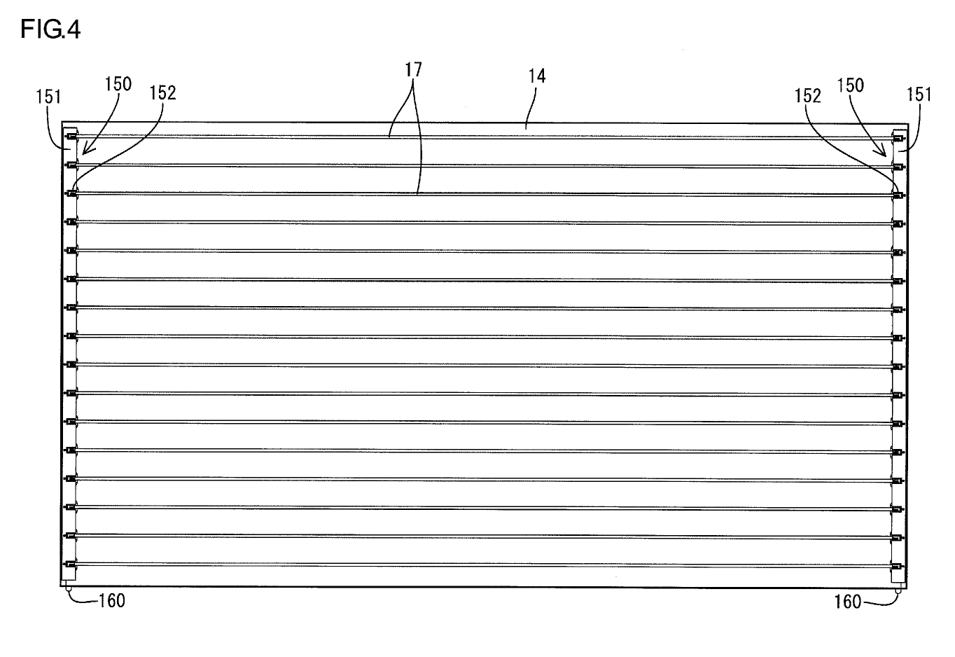

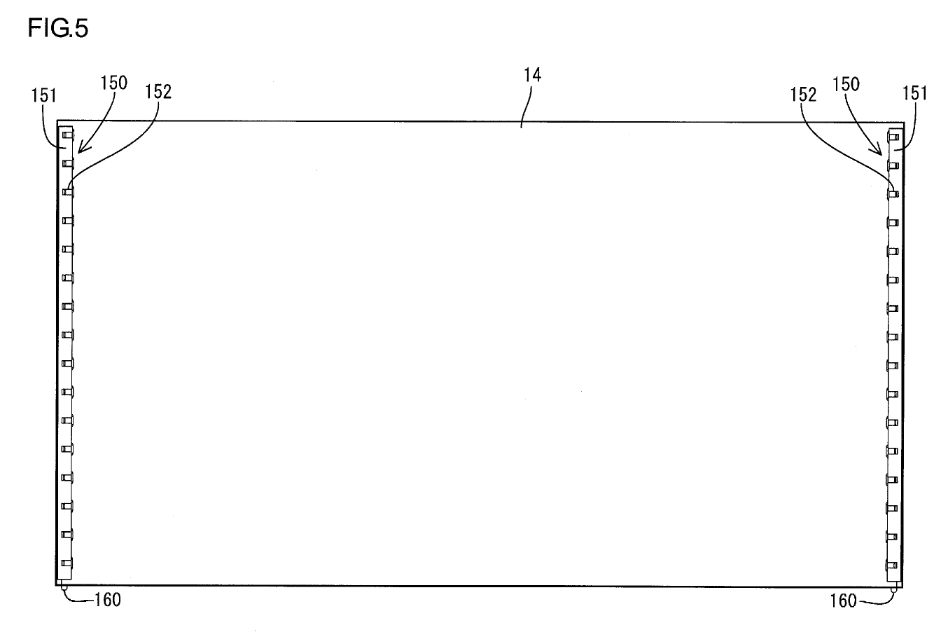

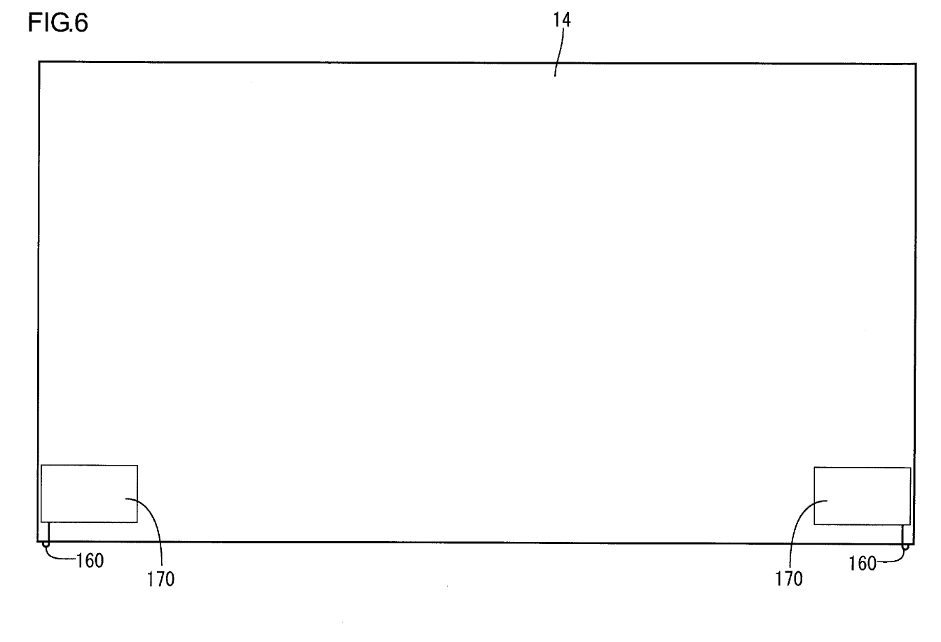

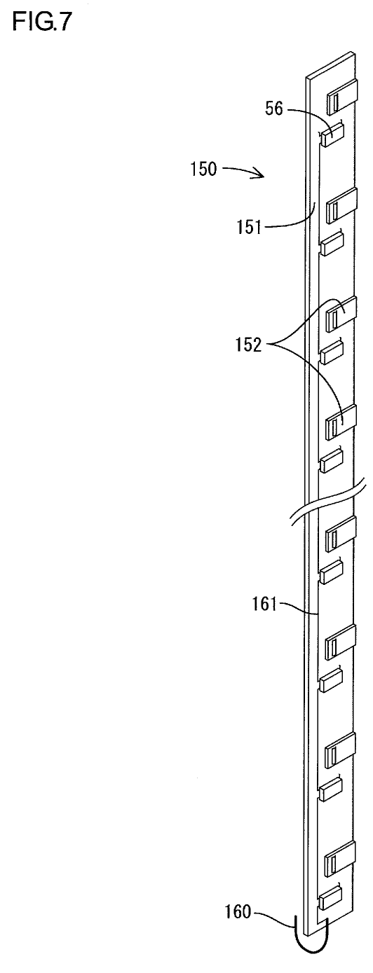

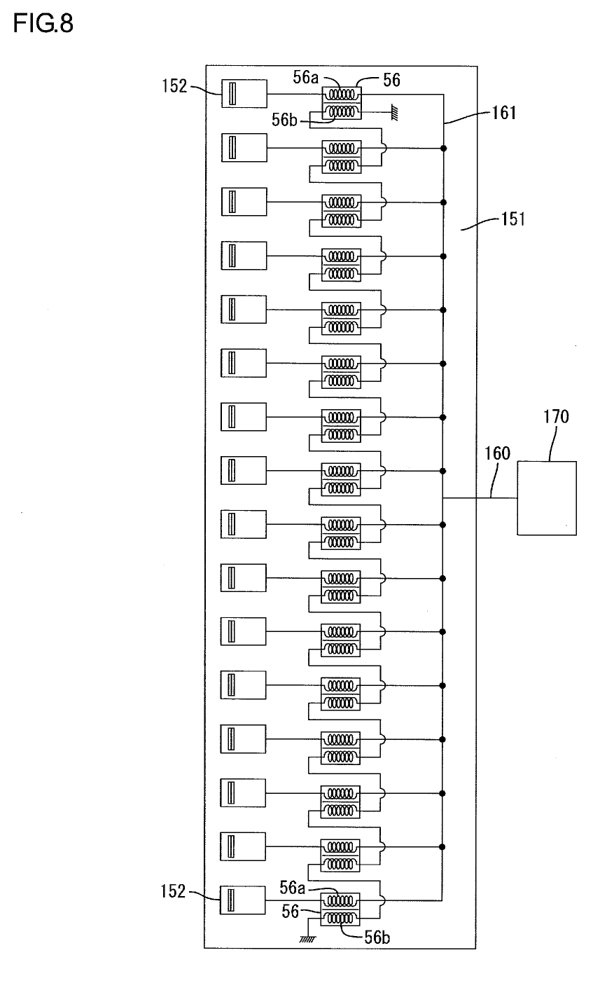

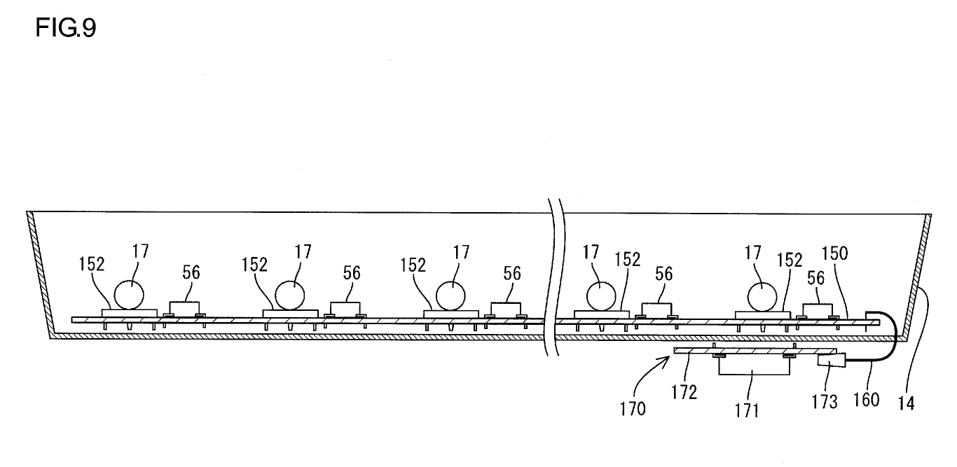

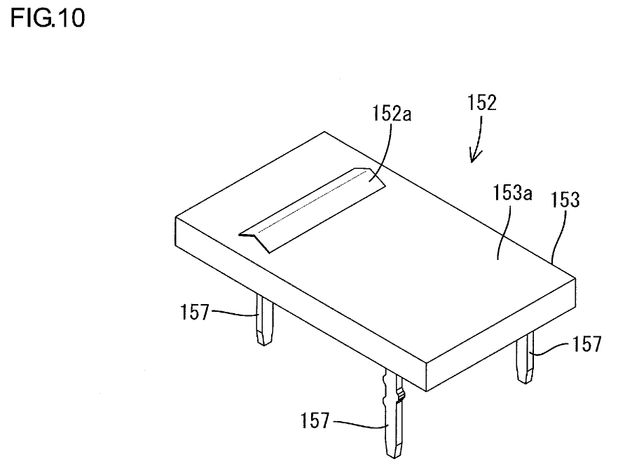

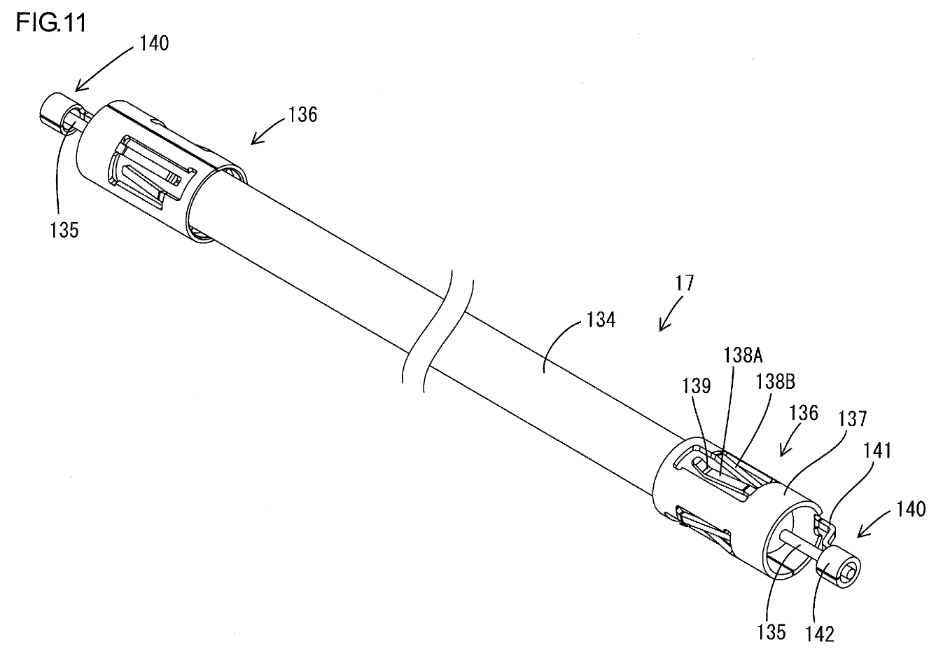

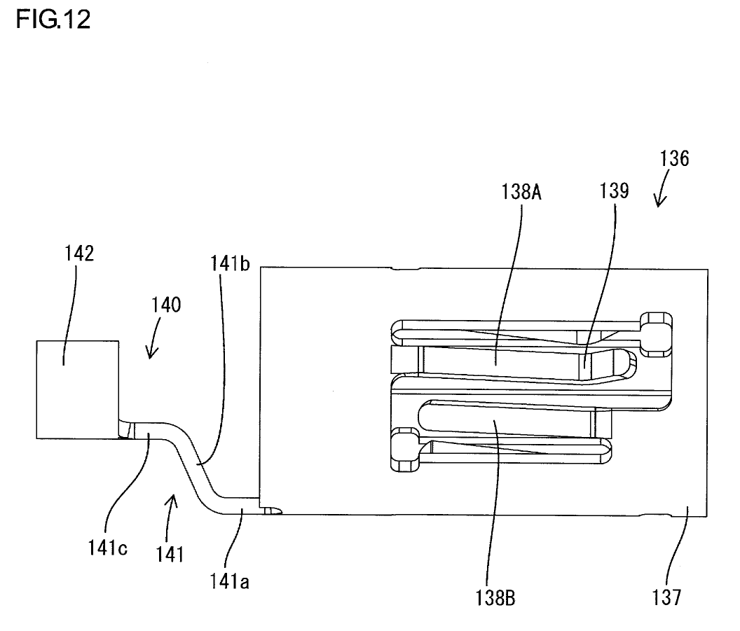

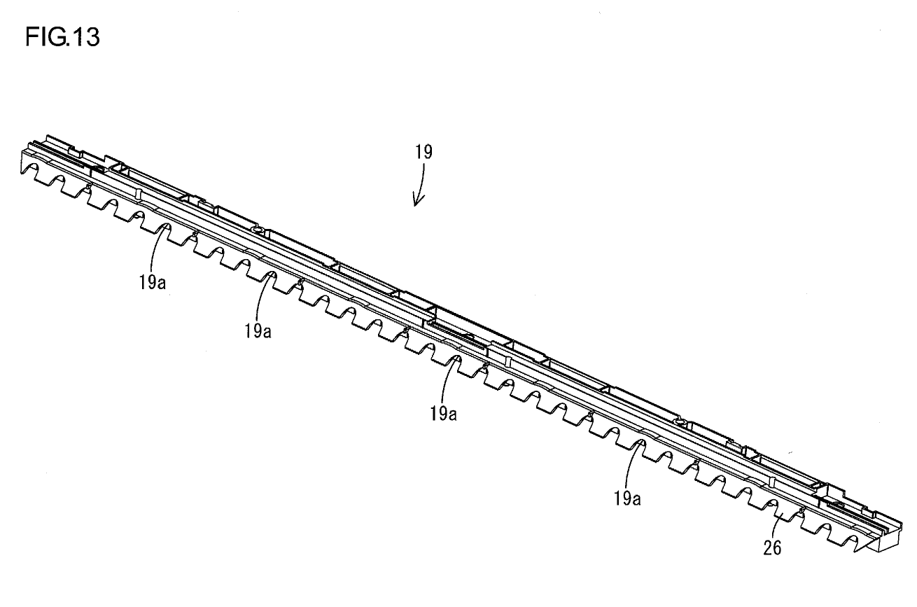

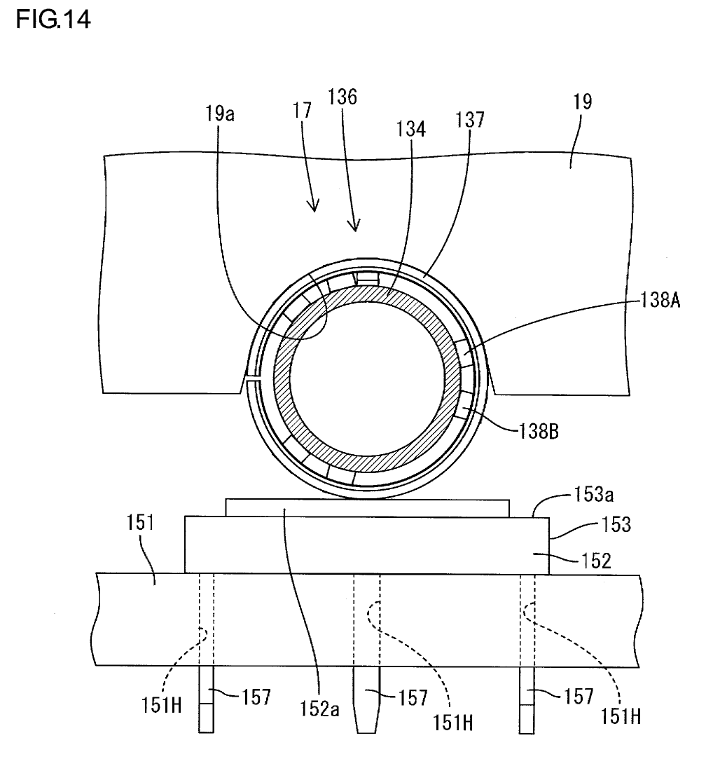

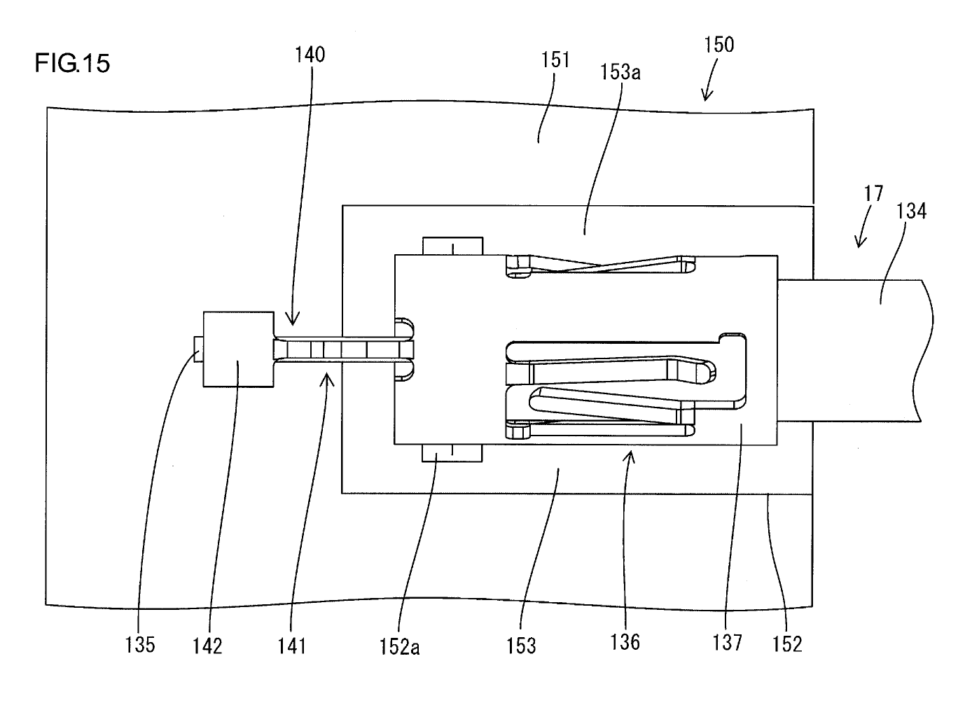

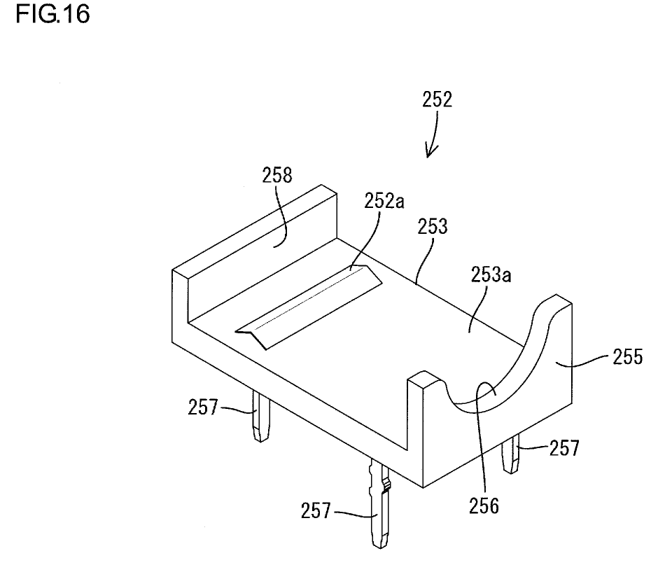

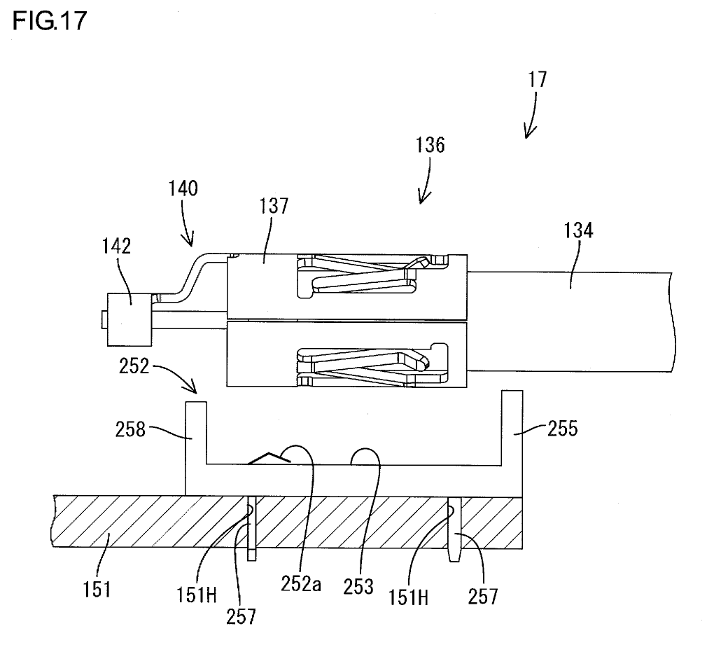

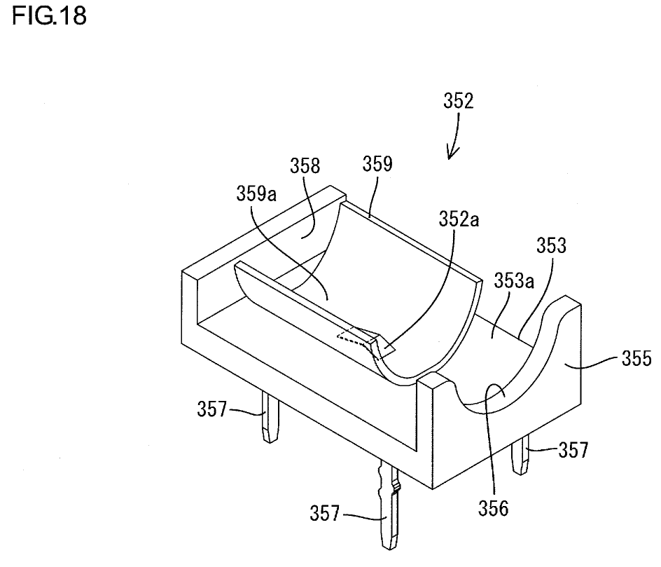

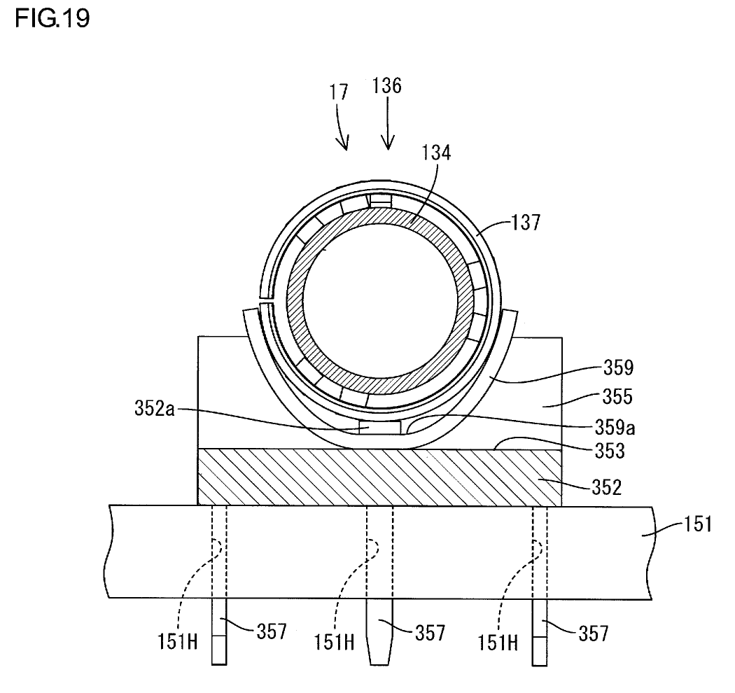

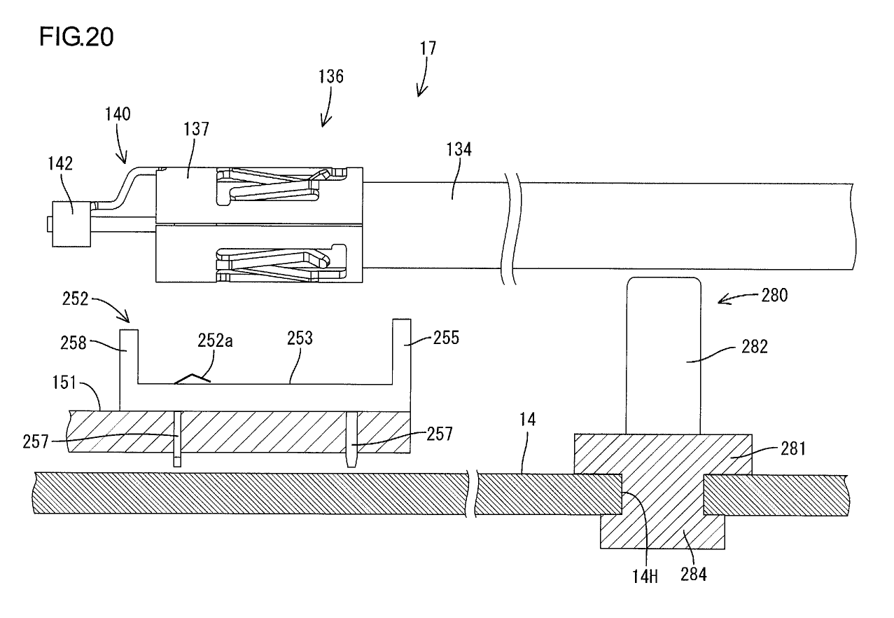

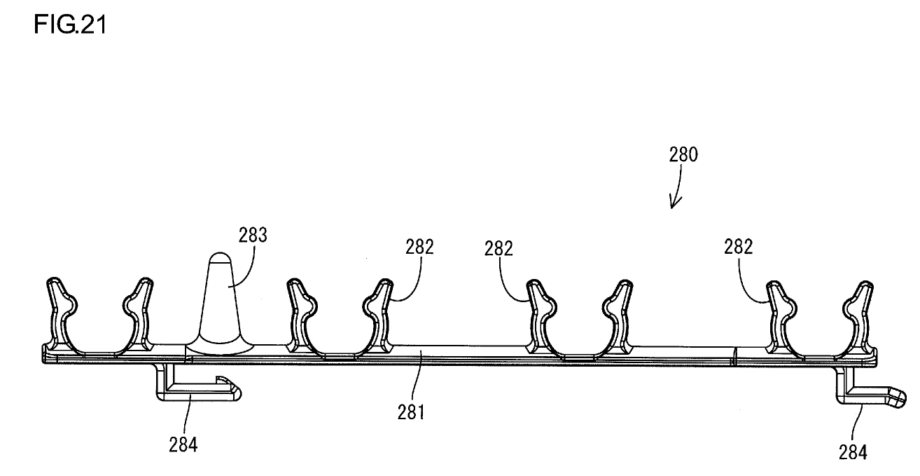

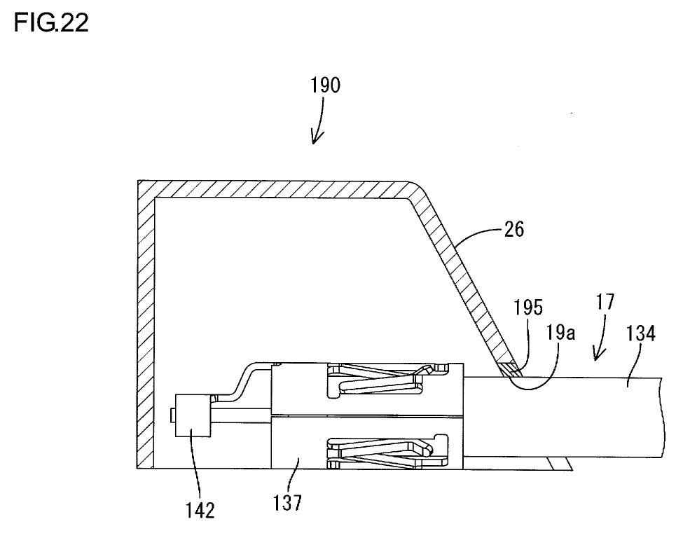

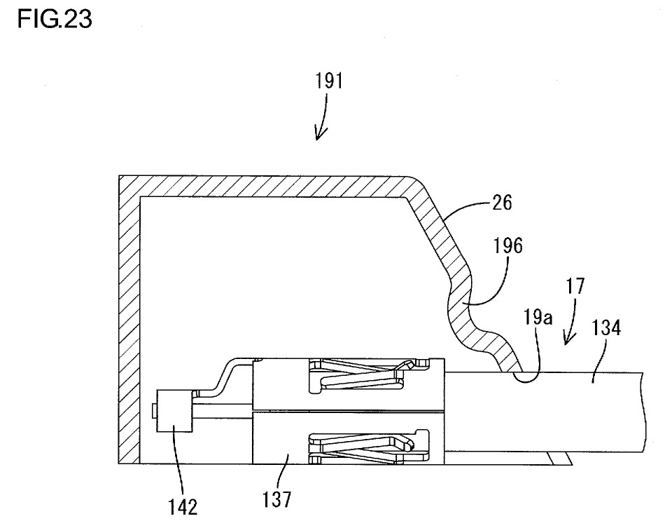

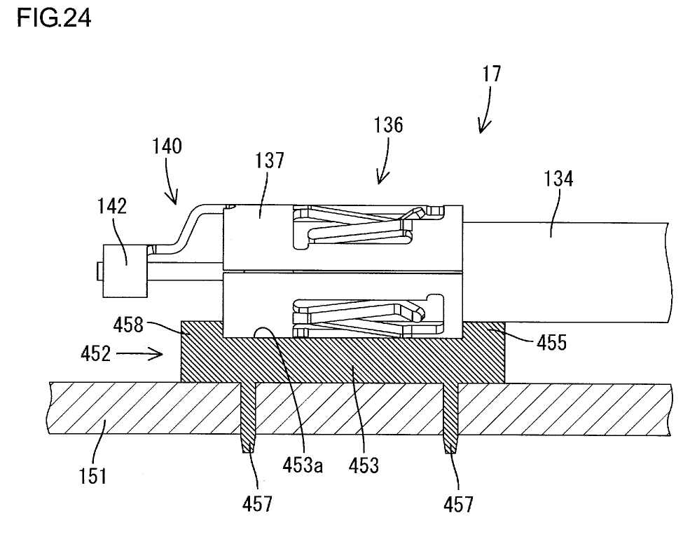

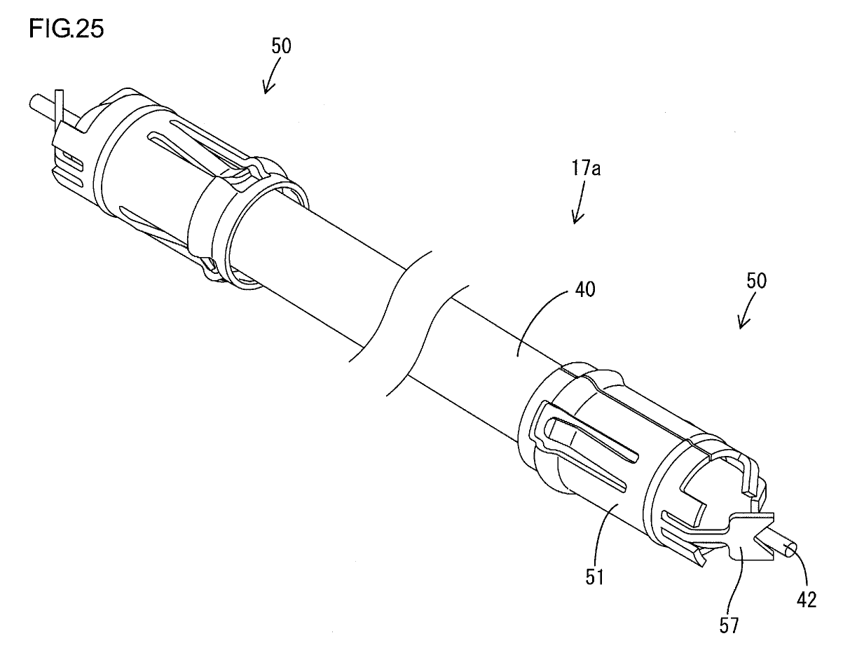

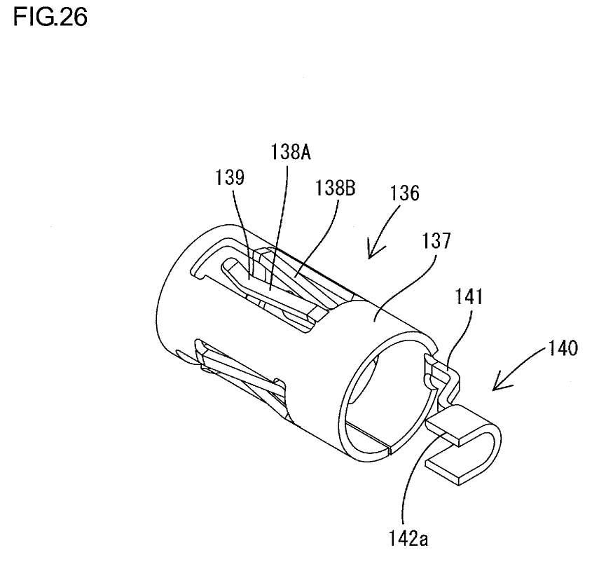

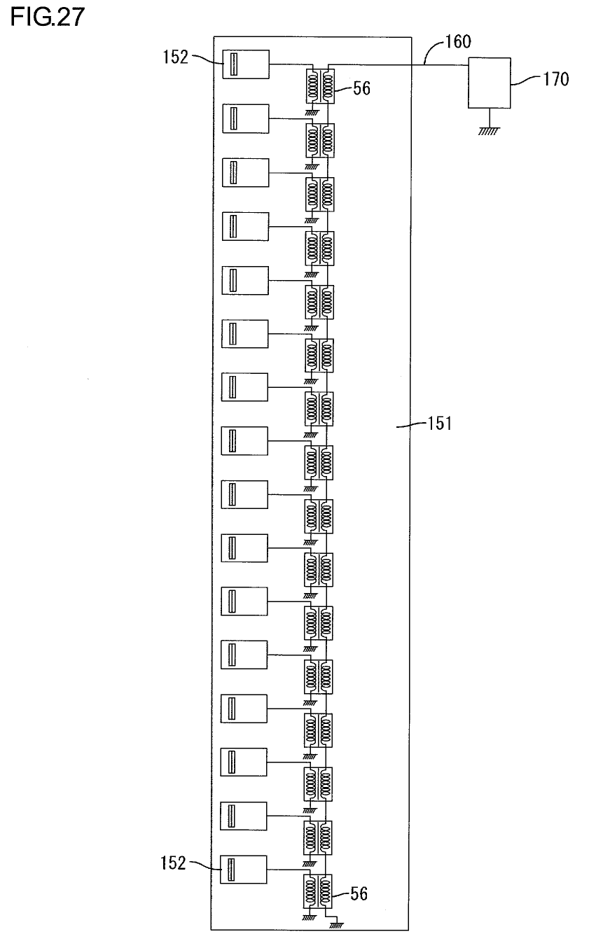

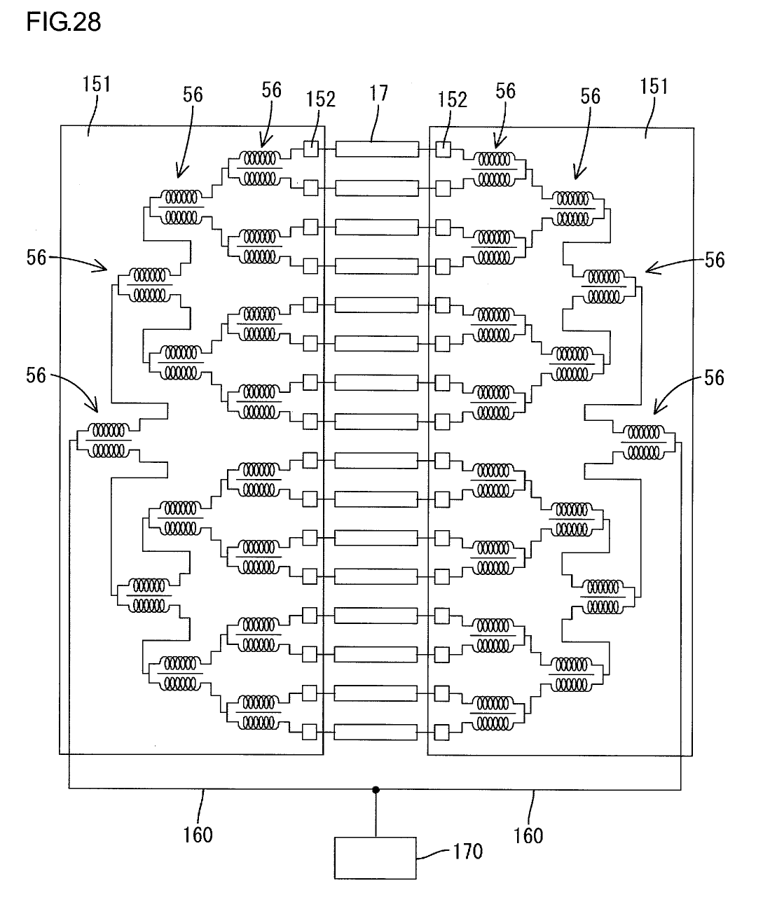

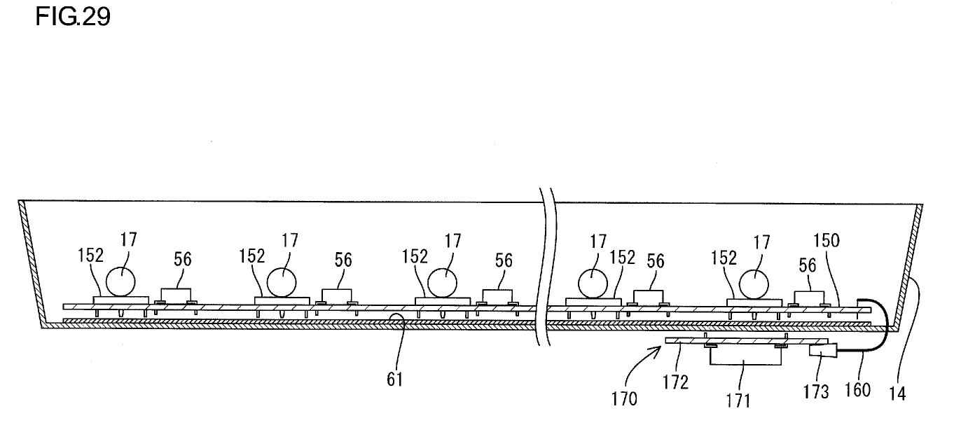

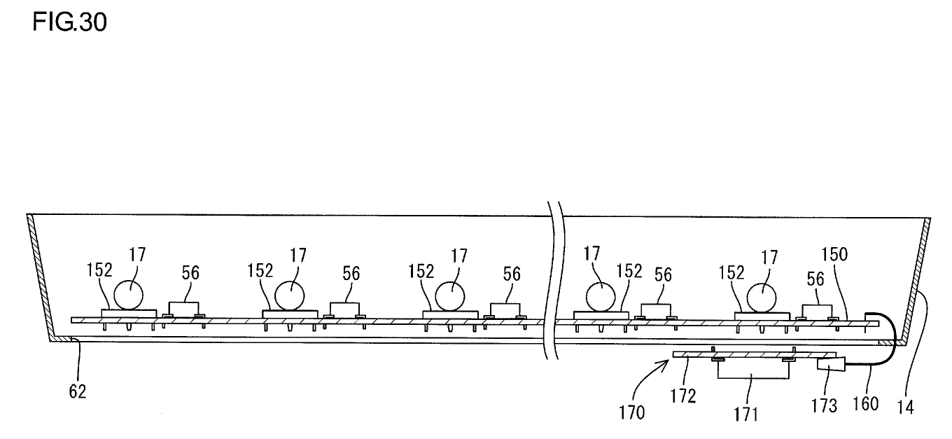

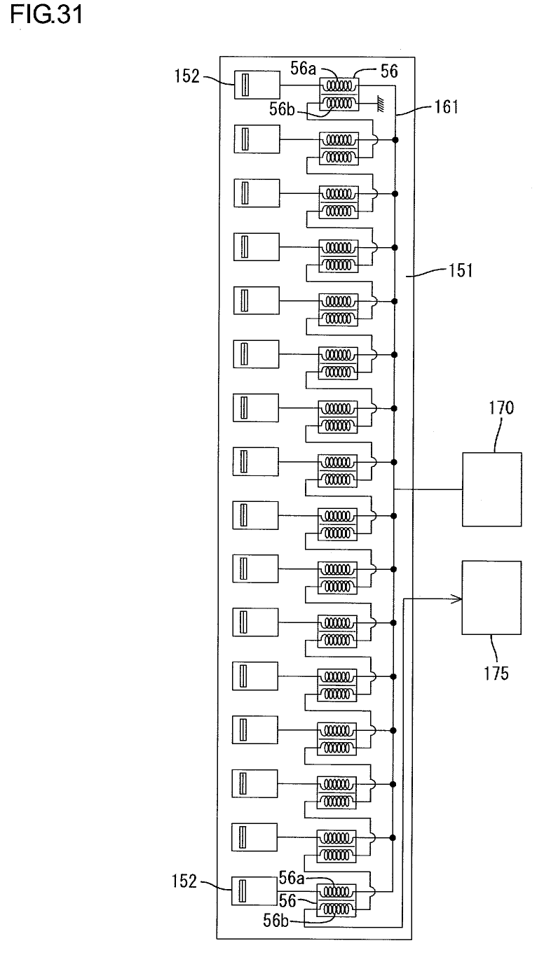

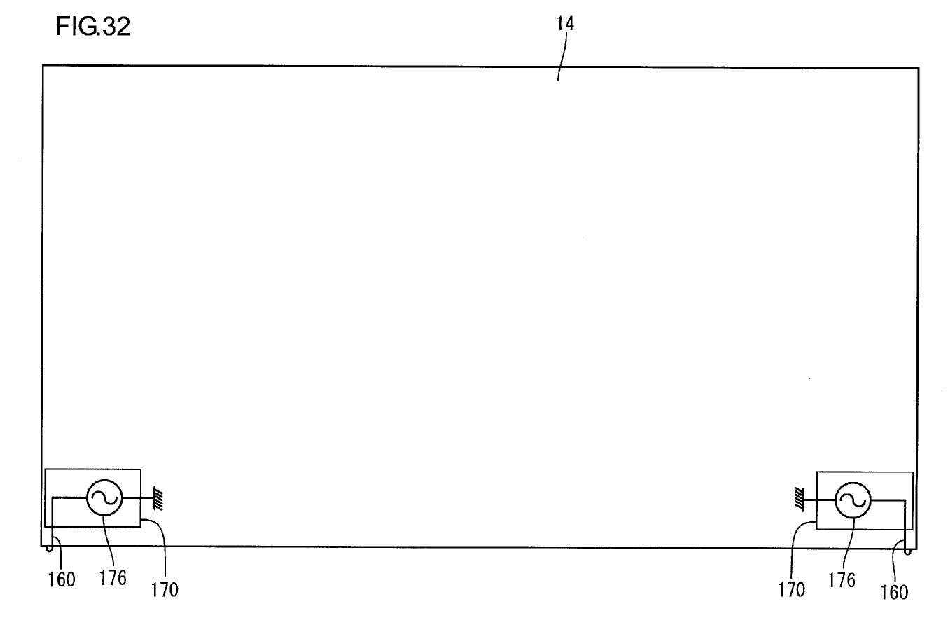

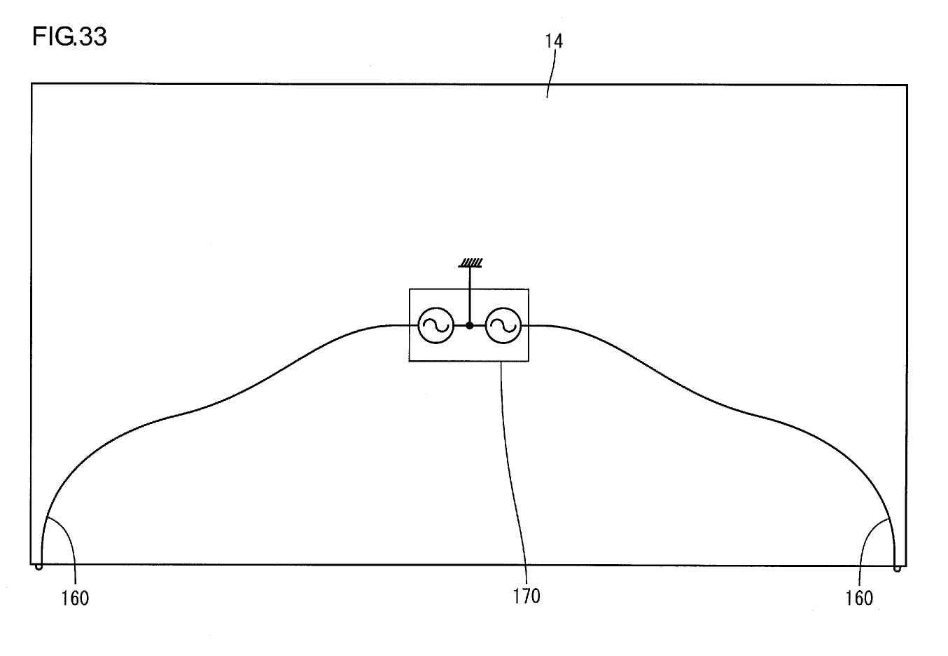

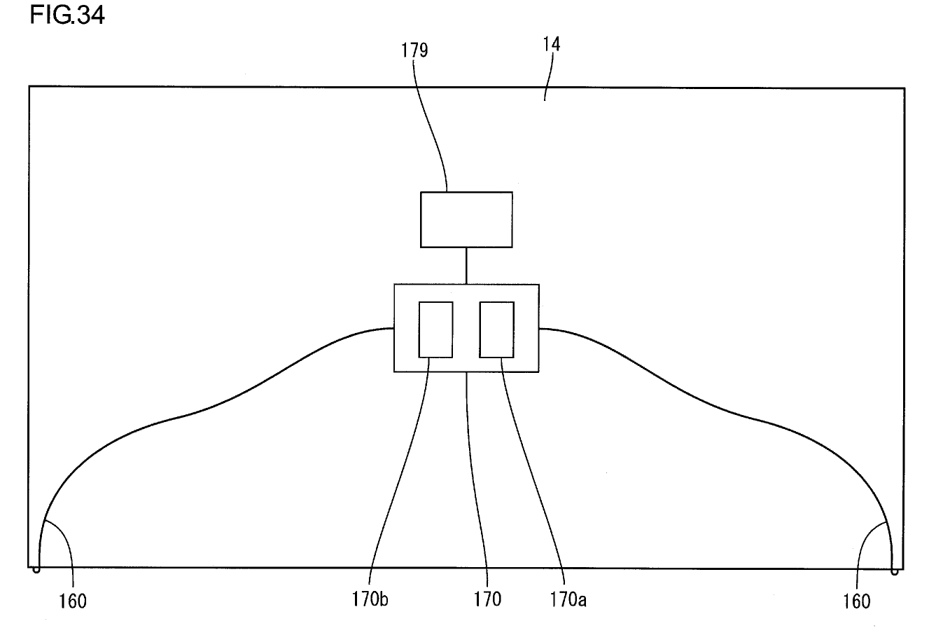

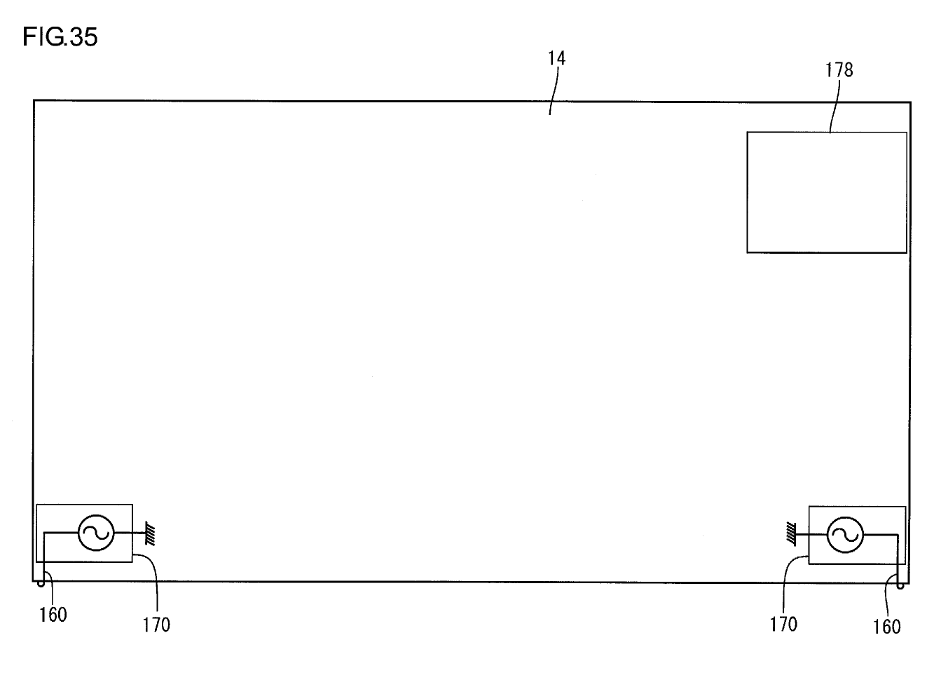

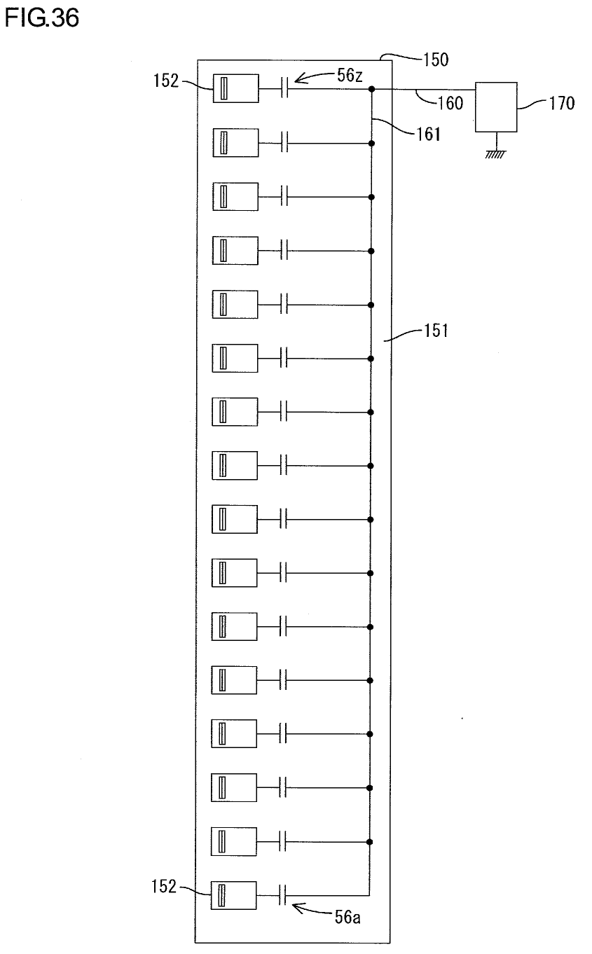

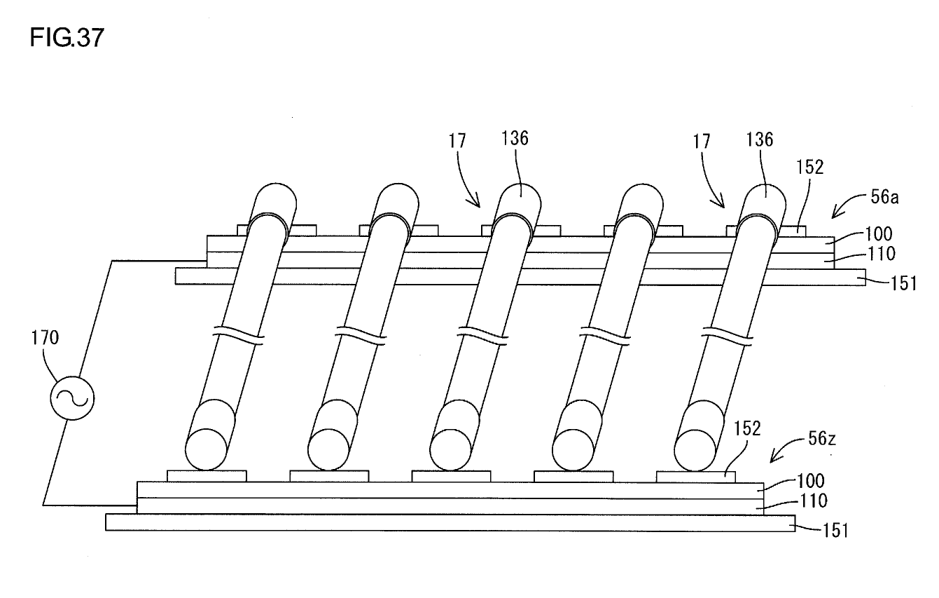

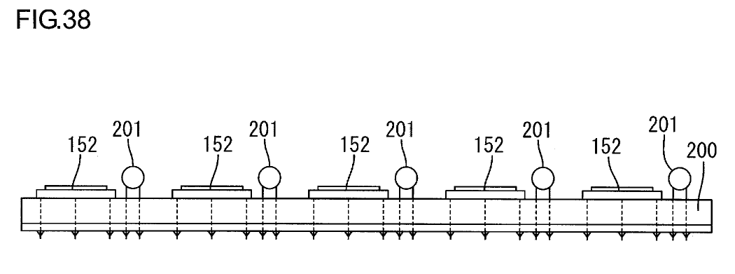

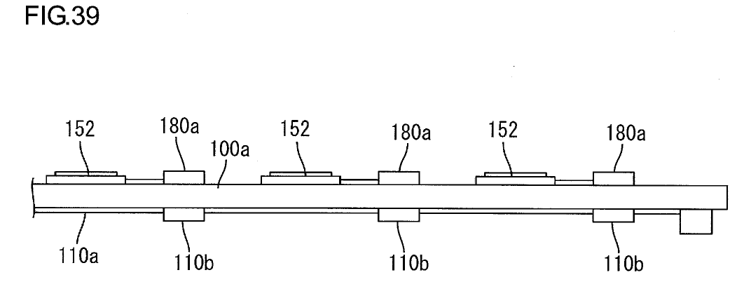

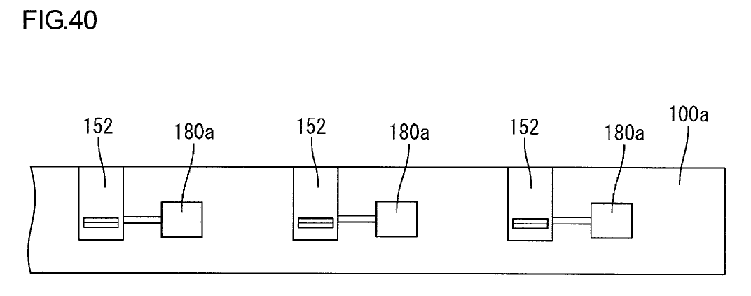

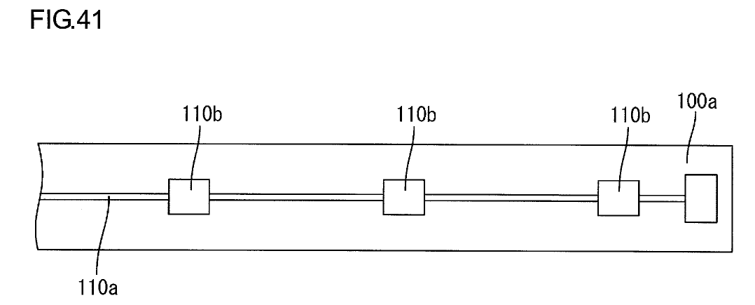

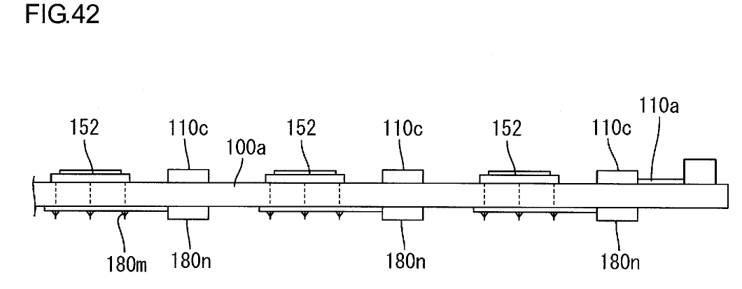

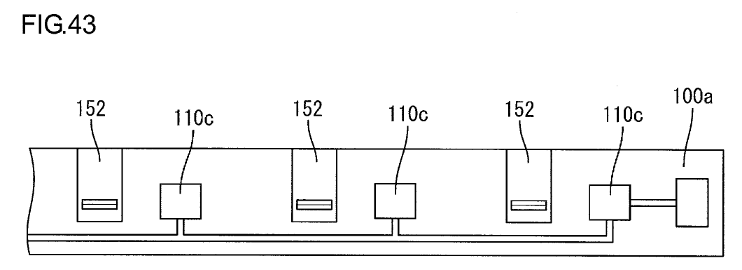

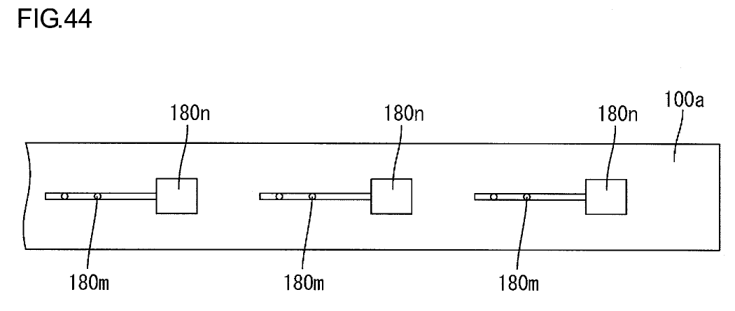

### BRIEF DESCRIPTION OF THE DRAWINGS

[FIG. 1] is an exploded perspective view illustrating a general construction of a television receiver;

[FIG. 2] is an exploded perspective view illustrating a general construction of a liquid crystal display device (display device);

[FIG. 3] is a cross-sectional view of FIG. 2 along the line A-A;

[FIG. 4] is a front view illustrating a construction of a main part of the lighting device;

[FIG. 5] is a front view illustrating a construction of the main part illustrated in FIG. 4 without cold cathode tubes;

[FIG. 6] is a rear view illustrating a construction of a main part of the lighting device;

[FIG. 7] is a perspective view illustrating constructions of a power relay board;

[FIG. 8] is an explanatory view illustrating a driving power supplying mechanism for the cold cathode tubes;

[FIG. 9] is an explanatory schematic view illustrating a configuration related to power supply;

[FIG. 10] is a perspective view illustrating a construction of a relay terminal;

[FIG. 11] is a perspective view illustrating a construction of the cold cathode tube;

[FIG. 12] is a plan view illustrating a construction of a ferrule connected to the cold cathode tube;

[FIG. 13] is a perspective view illustrating a construction of a lamp holder;

[FIG. 14] is a front view illustrating a construction of the cold cathode tube placed on the relay terminal;

[FIG. 15] is a plan view illustrating a construction of the cold cathode tube placed on the relay terminal;

[FIG. 16] is a perspective view illustrating a modification of the relay terminal;

[FIG. 17] is an explanatory view illustrating a positional relation between the relay terminal and the cold cathode tube in FIG. 16;

[FIG. 18] is a perspective view illustrating a modification of the relay terminal;

[FIG. 19] is an explanatory view illustrating a positional relation between the relay terminal and the cold cathode tube in FIG. 18;

[FIG. 20] is an explanatory view illustrating a construction using a lamp clip;

[FIG. 21] is a front view illustrating a construction of the lamp clip;

[FIG. 22] is an explanatory view illustrating a modification of the lamp holder;

[FIG. 23] is an explanatory view illustrating another modification of the lamp holder;

[FIG. 24] is an explanatory view illustrating a modification of the relay terminal and a positional relation between the relay terminal and the cold cathode tube;

[FIG. 25] is a perspective view illustrating a modification of the cold cathode tube;

[FIG. 26] is a perspective view illustrating a modification of a ferrule;

[FIG. 27] is an explanatory view illustrating a modification of the power supplying mechanism;

[FIG. 28] is an explanatory view illustrating another modification of the power supplying mechanism;

[FIG. 29] is an explanatory view illustrating an example of a mechanism that provides insulation between a chassis and the power relay board;

[FIG. 30] is an explanatory view illustrating an example of a mechanism that provides insulation between a chassis and the power relay board;

[FIG. 31] is an explanatory view illustrating another modification of the driving power supplying mechanism;

[FIG. 32] is an explanatory view illustrating the power boards provided on a rear surface of the chassis;

[FIG. 33] is an explanatory view illustrating a modification of an arrangement of the power board;

[FIG. 34] is an explanatory view illustrating a modification of an arrangement of the power board;

[FIG. 35] is an explanatory view illustrating a modification of an arrangement of the power board;

[FIG. 36] is a plan schematic view illustrating a modification of the power supply board;

[FIG. 37] is an explanatory view illustrating a modification of the power supply board;

[FIG. 38] is a cross-sectional schematic view illustrating a modification of the power supply board;

[FIG. 39] is a cross-sectional schematic view illustrating a modification of the power supply board;

[FIG. 40] is a plan schematic view illustrating the power supply board in FIG. 39;

[FIG. 41] is a rear schematic view illustrating the power supply board in FIG. 39;

[FIG. 42] is a cross-sectional schematic view illustrating a modification of the power supply board;

[FIG. 43] is a plan schematic view illustrating the power supply board in FIG. 42; and

[FIG. 44] is a rear schematic view illustrating the power supply board in FIG. 42;

### BEST MODE FOR CARRYING OUT THE INVENTION

An embodiment of the present invention will be explained with reference to drawings.

FIG. 1 is an exploded perspective view illustrating a general construction of a television receiver. FIG. 2 is an exploded perspective view illustrating a general construction of a liquid crystal display device (display device) 10 included in the television receiver. FIG. 3 is a cross-sectional view of FIG. 2 along the line A-A. FIG. 4 is a front view illustrating a construction of a main part of a backlight device included in the liquid crystal display device 10. FIG. 5 is a front view illustrating a construction of the main part of the backlight device. FIG. 6 is a rear view illustrating a construction of the main part of the backlight device.

As illustrated in FIG. 1, the television receiver TV of the present embodiment includes a liquid crystal display device (display device) 10, front and rear cabinets Ca, Cb that house the liquid crystal display device 10 therebetween, a power source P, a tuner T and a stand S. An overall view of the liquid crystal display device 10 is a landscape rectangular. As illustrated in FIG. 2, it includes a liquid crystal panel 11, which is a display panel having a rectangular plan view, and a backlight device (lighting device for a display device) 12, which is an external light source. They are integrally held by a bezel 13 and the like.

The liquid crystal panel 11 has a known configuration such that liquid crystal (a liquid crystal layer) that changes its optical characteristics according to applied voltages is sealed between a transparent TFT substrate and a transparent CF substrate. A number of source lines and gate lines are formed on an inner surface of the TFT substrate. The source lines extend in a longitudinal direction and the gate lines extend a transverse direction so as to form a grid pattern. Color filters including red (R), green (G) and blue (B) are provided on the CF substrate. Polarizing plates are attached to surfaces of those substrates on sides opposite from the liquid crystal side.

The backlight device 12 is a so-called direct backlight device in which a light source is arranged closely below the liquid crystal panel 11. The backlight device 12 includes a chassis 14, a reflective sheet 14a, an optical member 15, a frame 16, cold cathode tubes (light sources (linear light sources, tubular light sources)) 17 and lamp holders (light source cover) 19. The chassis 14 has an opening on the front (light output side). The reflective sheet 14a is placed inside the chassis 14. The optical members 15 are arranged around the opening of the chassis 14. The frame 16 holds the optical member 15. The cold cathode tubes 17 are installed in the chassis 14. The lamp holders 19 shield ends of the cold cathode tubes 17 from light and have light reflectivity.

The optical member 15 has a function that converts linear light emitted from each cold cathode tube 17, which is a linear light source, to planar light, and directs the planar light toward an effective display area of the liquid crystal panel 11 (directivity).

The chassis 14 is formed of metal and in a substantially box-shape having a rectangular plan view and an opening on the front (light output side). The reflective sheet 14a is made of synthetic resin and a white material having good reflectivity. It is disposed in the chassis 14 so as to cover an entire inner surface of the chassis 14. The reflective sheet 14a directs most light emitted from each cold cathode tube 17 toward an opening side of the chassis 14.

As illustrated in FIGS. 4 and 5, power relay boards (power relay member) 150 for relaying driving power supplied from the power supply board 170 (explained later, see FIG. 6) to the cold cathode tubes 17 are disposed on an inner surface of the chassis 14. Each of the power relay boards 150 includes a base 151 that is made of an insulating substrate and chip relay terminals 152 each of which corresponds to each cold cathode tube 17 one by one. In the present embodiment, the base 151 is mounted to each side of the chassis 14 so as to overlap with each end of the cold cathode tube 17. As illustrated in FIG. 6, power supply boards 170 including inverter circuits for supplying driving power to the cold cathode tubes 17 are disposed on the rear surface of the chassis 14.

Configuration and operation for supplying the driving power to the cold cathode tubes 17 will be explained. A two-side driving system is used here. As illustrated in FIG. 32, power sources 176 are included in the power supply boards 170 arranged on either side and supply power to the cold cathode tubes 17 via their both ends.

FIG. 7 is a perspective view illustrating a general construction of the power relay board 150 including the relay terminals 152. FIG. 8 is an explanatory view illustrating a circuit configuration related to power supply. FIG. 9 is an explanatory schematic view related to the power supply. FIG. 10 is a perspective view illustrating a construction of the clip terminal 152. FIG. 11 is a perspective view illustrating a construction of the cold cathode tube 17. FIG. 12 is a plan view illustrating a construction of the ferrule 136 connected to the cold cathode tube 17. FIG. 13 is a perspective view illustrating a construction of the lamp holder 19 that covers the cold cathode tube 17 from the front side. FIG. 14 is a front view illustrating a construction of the cold cathode tube 17 placed on the relay terminal 152. FIG. 15 is a plan view illustrating a construction of the cold cathode tube 17 placed on the relay terminal 152.

[Cold Cathode Tubes 17]

First, the construction of each cold cathode tube 17 will be explained.

As illustrated in FIG. 11, the cold cathode tube 17 is constructed of a glass tube 134, outer leads 135 and ferrules (electrical terminals) 136. The glass tube 134 is a linear glass tube having a longitudinal overall shape and a circular cross section. The outer leads 135 are made of metal (e.g., nickel or cobalt containing metal) and formed in a longitudinal shape having a circular cross section with the same center as the glass tube 134. They extend linearly from both ends of the glass tube 134. The ferrules 136 are mounted to the respective ends of the glass tube 134. Mercury is sealed inside the glass tube 134. The ends of the glass tube 134 are heated and melted so as to form a substantially dome shape. The outer leads 135 penetrate through the domes.

As illustrated in FIG. 12, each ferrule 136 is a single part formed in that shape by bending or hammering a metal plate (e.g., a stainless plate) punched out in a predetermined shape. The ferrule 136 includes one body 137 and a pair of conductive pieces 140. The body 137 has a cylindrical overall shape with the same center as the glass tube 134. An inner diameter of the body 137 is defined slightly larger than an outer diameter of the glass tube 134.

The body 137 has three pairs of elastic holding pieces 138A, 138B formed at an equal angle pitch in a circumferential direction by cutting parts of the body 137 in slits.

The first elastic holding piece 138A among a pair of the elastic holding pieces 138A, 138B has a cantilever-like shape that extends generally toward the rear (specifically, toward an inner direction slightly diagonal to the radial direction). It is elastically flexible in the radial direction with its base portion (front end) as a pivot point. An extending end (rear end) of the first elastic holding piece 138A has a bending portion 139 where the piece is bent at an angle outward in a radial direction. A surface of the bending portion 139 on a crest side (i.e., a surface facing inward) is a contact point that will come in contact with a periphery of the glass tube 134. An imaginary circle that connects the contact points of three of the first elastic holding pieces 138A has the same center as the body 137. A diameter of the imaginary circle is smaller than the outer diameter of the glass tube 134 when the first elastic holding pieces 138A are in a free state without any elastic deflection.

The second elastic holding piece 138B among a pair of the elastic holding pieces 138A, 138B is provided adjacent to the first elastic holding piece 138A in the circumferential direction. It has a cantilever-like shape that extends generally toward the front (specifically, toward an inner direction slightly diagonal to the radial direction), which is an apposite direction from the extending direction of the first elastic holding piece 138A. It is elastically flexible in the radial direction with its base portion (rear end) as a pivot point. An extending end of the second elastic holding piece 138B is a contact point that will come into contact with a periphery of the glass tube 134. An imaginary circle that connects the contact points of three of the second elastic holding pieces 138B has the same center as the body 137. A diameter of the imaginary circle is smaller than the outer diameter of the glass tube 134 when the second elastic holding pieces 138B are in a free state without any elastic deflection.

The body 137 has cantilever-like conductive pieces 140 that extend from ends of the body 137 forward. Each conductive piece 140 has a stem portion 141 that continues from the front end of the body 137 and a drum-shaped portion 142 that extends from a front end (extending end) of the stem portion 141 further forward. The stem portion 141 has a base section 141a, a middle section 141b and an end section 141c. The base section 141a extends from the body 137 along an axis of the body 137 such that the surfaces thereof and the body 137 are on the same flat plane. The middle section 141b extends from an extending end of the base section 141a toward the axis of the body 137, that is, inward in the radial direction of the body 137. The end section 141c extends from an extending end of the middle section 141b along the axis of the body 137. The drum-shaped portion 142 is connected with the extending end of the end section 141c. A width of the stem portion 141 is sufficiently smaller than a length of the stem portion 141. This allows the stem portion 141 to elastically deform in the radial direction of the body 137 and in a direction that crosses the radial direction (a direction that crosses the longitudinal direction of the stem portion 141). It also allows the stem portion 141 to twist around an axis, which is the stem portion 141 itself. The drum-shaped portion 142 is formed in a drum-like shape by bending a portion that extends from the extending end of the stem portion 141 in the lateral direction so as to have an axis substantially in the same position as the axis of the body 137. The drum-shaped portion 142 can be displaced in a helical direction and a radial direction of the ferrule 136 with elastic flexibility of the stem portion 141.

[Power Relay Board 150]

Next, a construction of the power relay boards 150 will be explained.

Each power relay board 150 has a function for relaying power supply to the cold cathode tubes 17. As illustrated in FIG. 7, each of the power relay boards 150 includes an elongated base 151 that is formed of an insulating substrate and mounted to each end of the chassis 14 (see FIGS. 4 and 5), a plurality of relay terminals 152 mounted on the front surface of the base 151, and balance coils (balancing components) 56 for outputting a constant electrical current for the driving power supplied to each relay terminal 152. The base 151 has three mounting through holes for each relay terminal 152 as illustrated in FIG. 14.

As illustrated in FIG. 10, each relay terminal 152 includes a base 153 that is formed of conductive metal and formed in a chip or a rectangular shape and a leaf spring (elastic member) 152a that is formed of a conductive material and provided on a placing surface 153a of the base 153. The placing surface 153a is a flat surface. The leaf spring 152a is equipotential to the base 153 and it applies an elastic reaction force to the ferrule 136 that is placed on the placing surface 153a. The leaf spring 152a is elastically deformed by an urging force applied from the ferrule 136 to the placing surface 153a. Namely, the leaf spring 152a is disposed between the placing surface 153a and the ferrule 136 in the elastically deformed state. Three legs 157 are integrally formed on a rear surface of the base 153. The relay terminal 152 is not housed in a housing member and the like made of a synthetic resin, and directly fixed to the base 151 by soldering and the like without any covering with the legs 157 passed through the mounting holes in the base 151.

[Lamp Holder 19]

The lamp holder 19 covers the ends (ferrule 136) of the cold cathode tubes 17 as illustrated in FIG. 1 and has a configuration illustrated in FIG. 13. The lamp holder 19 is formed in an elongated substantially box shape extending in the alignment direction of the cold cathode tubes 17, and is made of a synthetic resin having a surface in white color that provides reflectivity. A sloped cover (sloped portion) 26 extends from an upper surface of the lamp holder 19 toward a center of the cold cathode tubes 17 and toward a bottom plate of the chassis 14. Openings 19a into which the cold cathode tubes 17 are inserted are formed in the sloped cover 26. The number of openings 19a is same as that of cold cathode tubes 17. The portions of the cold cathode tubes 17 that are inserted in the lamp holder 19 from the opening 72 (covered portions) are connected to the power supply board 170 (see FIG. 6) via the power relay board 150 with conductivity. In the present embodiment, as illustrated in FIG. 14, the lamp holder 19 presses the upper side (front side) of the cold cathode tube 17 to urge the cold cathode tube 17 toward the placing surface 153a of the relay terminal 152.

[Balance Coil 56]

Each balance coil 56 is a balancing component and includes a primary coil 56a and a secondary coil 56b as illustrated in FIG. 8. One balance coil 56 is provided for each relay terminal 152 and integrally arranged with the relay terminal 152 on the base 151. Each balance coil 56 is connected to the power supply board (power source) 170 in parallel, and each balance coil 56 is connected to a common line 161 in parallel here. Electrical connection with the power supply board (power source) is collectively made through a line (harness) 160 connected to the common line 161. The primary coils 56a are connected to the respective relay terminals 152 and the secondary coils 56b are connected with each other in series.

The balance coils 56 and the power supply board 170 are connected via lines that are less than the cold cathode tubes 17, specifically, connected via one harness (power supply path) 160. The harness 160 is routed from an edge of the base 151 disposed on the inner surface (inner surface side) of the chassis 14 to the power supply board 170 disposed on the outer surface (outer surface side) of the chassis 14, for example, as illustrated in FIG. 9.

[Power Supply Board 170]

As illustrate in FIG. 9, the power supply board 170 includes a circuit board 172 having circuits on the rear surface (on the opposite side from the chassis 14), electronic components 171 mounted on the circuit board 172, and an on-board connector 173 mounted on the circuit board 172. The electronic components 171 include a transformer, and the circuit board 172 is configured as an inverter circuit board that generates a high frequency voltage. The on-board connector 173 is mounted on an edge area of the circuit board 172 and connected to the line 160. The power supply board 170 is assembled and fixed to the chassis 14 with screws and the like.

[Power Supply Method]

Reliable power supply to the cold cathode tubes 17 can be achieved by the power relay board 150 provided with the relay terminals 152 and the lamp holders 19.

When the ferrule 136 of the cold cathode tube 17 is placed on the placing surface 153a of the relay terminal 152, the driving power can be supplied to the cold cathode tube 17. There is provided no clip mechanism for holding the cold cathode tubes 17.

Namely, as illustrated in FIG. 14, the cold cathode tube 17 (the ferrule 136, subsequently) urged by the lamp holder 19 that is provided independently from the relay terminal 152 is received by the leaf spring 152a with its elastic reaction force. Accordingly, the leaf spring 152a is disposed between the placing surface 153a and the ferrule 136 in an elastically deformed state so as to achieve reliable contact (conductivity) between the ferrule 136 and the relay terminal 152 (including the leaf spring 152a).

According to the television receiver TV of the present embodiment, the liquid crystal display device 10 includes the backlight device (lighting device) 12 having the configuration of the present invention. Therefore, it provides the following operation effects.

In the power relay board 150 connecting the power supply board 170 and the cold cathode tubes 17, when the ferrule 136 of the cold cathode tube 17 is placed on the placing surface 153a of the relay terminal 152, the driving power can be supplied to the cold cathode tube 17. The lamp holder 19 urging the cold cathode tube 17 toward the placing surface 153a is provided independently from the relay terminal 152. Therefore, the relay terminal 152 is configured to be in a quite simple chip and conductivity to the cold cathode tube 17 becomes reliable. Namely, the member that urges the cold cathode tube 17 (lamp holder 19) is provided independently from the relay terminal 152, and therefore the relay terminal 152 has a simple configuration in which the ferrule 136 is placed on the placing surface 153a of the relay terminal 152 and is not required to have a configuration in which the cold cathode tube 17 is held or fixed by the holding member such as a clip and the like. This simplifies the configuration.

The conductive leaf spring 152a is disposed between the ferrule 136 and the placing surface 153a with being elastically deformed, and this ensures conductivity between the ferrule 136 and the placing surface 153a (relay terminal 152). As described above, in the present embodiment, the cold cathode tube 17 is urged toward the placing surface 153a by the lamp holder 19 to achieve reliable contact between the ferrule 136 and the placing surface 153a. The leaf spring 152a provided on the placing surface 135a enables the ferrule 136 and the placing surface 153a to be in contact with each other surely even if a slight position gap (relative movement) is caused between the ferrule 136 and the placing surface 153a. This ensures further reliable conductivity. Even if dimension error in manufacturing occurs in the relay terminal 152, the cold cathode tube 17 and the lamp holder 19, the leaf spring 152a absorbs the error to achieve the reliable contact between the ferrule 136 and the placing surface 153a.

In addition to the function for urging the cold cathode tube 17 toward the placing surface 153a, the lamp holder 19 also covers ends of the cold cathode tubes 17 that are non-light emitting portions, the ferrule 136 here, such that shadows of the non-light emitting portions are not projected on the illumination light.

Since the balance coils (balancing components) 56 are connected between the relay terminals 152 and the power supply board 170 to output the constant current for the driving power supplied to each relay terminal 152, the current supplied to each cold cathode tube 17 is constant. The balance coils 56 are used as balancing components. Therefore, the driving voltage is small and the lighting device is very preferable for the liquid crystal display device 10 included in the television receiver TV, which is a large-screen TV. Further, the amount of current supplied to each cold cathode tube 17 is kept at a constant level by using the balance coils 56. Therefore, the cold cathode tubes 17 are connected to a single power source 170 in parallel. As a result, a plurality of the relay terminals 152 and the balance coils 56 connected to the relay terminals 152 are provided integrally on the base 151, and electrical connection between the base 151 and the power supply board 170 is made with a single line. This simple configuration, that is, connection with a single line, allows the configuration for driving the cold cathode tubes 17 simple and can significantly reduce the cost.

The present invention is not limited to the embodiments explained in the above description. The following modifications may be included in the technical scope of the present invention, for example. In the following modifications, the same parts as the above embodiment are indicated by the same symbols and will not be explained.

[First Modification]

A modification of the relay terminal 152 is shown in FIGS. 16 and 17. FIG. 16 is a perspective view illustrating a configuration of a relay terminal 252 according to the first modification. FIG. 17 is an explanatory view illustrating a connecting relation between the relay terminal 252 and the cold cathode tube 17.

Each relay terminal 252 illustrated in FIG. 16 includes a base 253 that is formed of conductive metal and formed in a chip or a rectangular shape and a leaf spring (elastic member) 252a that is formed of a conductive material and provided on a placing surface 253a of the base 253. The placing surface 153a is a flat surface. The leaf spring 252a is equipotential to the base 253 and it applies an elastic reaction force to the ferrule 136 that is placed on the placing surface 253a. The leaf spring 252a is elastically deformed by an urging force applied from the ferrule 136 to the placing surface 253a. Namely, the leaf spring 252a is in the elastically deformed state between the placing surface 253a and the ferrule 136.

Three legs 257 are integrally formed on a rear surface of the base 253. Walls (light source movement restricting member) 255, 258 are formed at a front end and a rear end of the base 253.

As illustrated in FIG. 17, the walls 255, 258 extend upwardly from two ends of the placing surface 253a of the base 253 in an axial direction of the cold cathode tube 17 in a state that the cold cathode tube 17 is placed on the placing surface 253a. The walls 255, 258 restrict axial movement of the cold cathode tube 17. A part of the wall 255 among the walls 255, 258 that is provided at a front side (closer to a center of the cold cathode tube 17) is cut in an arc shape to form a cutaway portion 256 for accommodating a glass tube 134 of the cold cathode tube 17.

Considering the restriction of the movement of the cold cathode tube 17, at least the wall 258 provided at a back side (closer to the end of the cold cathode tube 17) is provided and the wall 255 provided at the front side may be omitted.

Similar to the relay terminal 152 of the above embodiment, the relay terminal 252 of the present embodiment is not housed in a housing member and the like made of a synthetic resin, and directly fixed to the base 151 by soldering and the like without any covering with the legs 257 passed through the mounting holes 151H in the base 151 to configure the power relay board 150.

[Second Modification]

Another modification of the relay terminal 152 is shown in FIGS. 18 and 19. FIG. 18 is a perspective view illustrating a configuration of the relay terminal 352 according to the second modification. FIG. 19 is an explanatory view illustrating a connecting relation between the relay terminal 352 and the cold cathode tube 17.

Each relay terminal 352 illustrated in FIG. 18 includes a base 353 that is formed of conductive metal and formed in a chip or a rectangular shape, an arc shaped cup (arc-shaped receiving member) 359 that is formed of conductive metal and placed on a placing surface 353a of the base 353, and a leaf spring (elastic member) 352a that is provided on a bottom surface of the cup 359. The cup 359 is configured to receive a lower portion of the ferrule 136 of the cold cathode tube 17, that corresponds to a half or less of the tubular periphery of the ferrule 136, and a cross section of the cup 359 with respect to a direction crossing to the axial direction of the cold cathode tube 17 is an arc having a semi-circular shape or smaller.

The leaf spring 352a is equipotential to the base 353 and the cup 359. The leaf spring 352a applies an elastic reaction force to the ferrule 136 that is placed on the placing surface 359a of the cup 359 with the ferrule 136 being received in the cup 359. The leaf spring 352a is elastically deformed by an urging force applied from the ferrule 136 to the placing surface 359a. Namely, the leaf spring 352a is in the elastically deformed state between the placing surface 359a and the ferrule 136.

Three legs 357 are integrally formed on a rear surface of the base 353. Walls (light source movement restricting member) 355, 358 are formed at a front end and a rear end of the base 353.

The walls 355, 358 extend upwardly from two ends of the placing surface 359a of the base 353 in an axial direction of the cold cathode tube 17 in a state that the cold cathode tube 17 is placed on the placing surface 359a. The walls 355, 358 restrict axial movement of the cold cathode tube 17. Apart of the wall 355 among the walls 355, 358 that is provided at a front side (closer to a center of the cold cathode tube 17) is cut in an arc shape to form a cutaway portion 356 for accommodating a glass tube 134 of the cold cathode tube 17. Considering the restriction of the movement of the cold cathode tube 17, at least the wall 358 provided at a back side (closer to the end of the cold cathode tube 17) is provided and the wall 355 provided at the front side may be omitted.

Similar to the relay terminal 152 of the above embodiment, the relay terminal 352 of the present embodiment is not housed in a housing member and the like made of a synthetic resin, and directly fixed to the base 151 by soldering and the like without any covering with the legs 357 passed through the mounting holes 151H in the base 151 to configure the power relay board 150.

[Third Modification]

A lamp clip 280 may be provided as holding means for holding the cold cathode tube 17. FIG. 20 is an explanatory view illustrating a relation between the lamp clip 280 and the cold cathode tube 17. FIG. 21 is a front view illustrating a construction of the lamp clip 280.

The lamp clip 280 fixes the cold cathode tubes 17 to the chassis 14. The lamp clip 280 includes a base plate (mounting plate) 281 that is placed on the chassis 14, holding portions 282, engagement portions 284 and a support pin 283. The holding portions 282 project from the base plate 281 toward the cold cathode tubes 17 to hold the cold cathode tubes 17. The engagement portions 284 project from the base plate 281 toward the chassis 14 to be engaged to a rear surface of the chassis 14 through mounting holes 14H provided in the chassis 14. The support pin 283 projects from the base plate 281 toward the cold cathode tubes 17 to support the optical member 15 that is provided on the front side from the cold cathode tubes 17.

In the above embodiments, the relay terminals 152, 252, 352 do not have a function for positioning the cold cathode tubes 17 in their alignment direction and the cold cathode tubes 17 are held and positioned only by the openings 19a of the lamp holder 19 (see FIG. 13). With using the lamp clip 280 of the second modification to position the cold cathode tubes 17 (especially in their alignment direction), attachment workability of the cold cathode tubes 17 is improved and problems such as a position gap of the cold cathode tubes 17 hardly occur. The lamp clip 280 has a function for urging the cold cathode tubes 17 toward the chassis 14 since it is configured to hold the cold cathode tubes 17 and to be attached to the chassis 14. Therefore, in such a case, the lamp clip 280 also urges the relay terminals 152, 252, 352 of the cold cathode tubes 17 toward the placing surface.

[Fourth Modification]

One modification of the lamp holder 19 that is the light source cover is illustrated in FIG. 22. FIG. 22 is an explanatory view illustrating a cross sectional configuration in a direction crossing to the longitudinal direction of a lamp holder 190 according to a fourth modification.

The lamp holder 190 of this modification includes a buffer member 195 at each opening 19a and in a state that the lamp holder 190 covers at least the ferrule 136 of the cold cathode tube 17 as illustrated in FIG. 22, the buffer member 195 is between the lamp holder 190 and the cold cathode tube 17. The buffer member 195 eases mechanical shock caused between the lamp holder 190 and the cold cathode tube 17 and sponge-like PORON is used for the buffer member 195 in this modification.

This configuration prevents that the lamp holder 190 excessively urges the cold cathode tubes 17 and damage or break them. That is, the buffer member 195 eases the urging force and ensures appropriate contact between the cold cathode tube 17 and the placing surface 153a. A material of the buffer member 195 is not limited if it can absorb the urging force such as a cloth.

[Fifth Modification]

Another modification of the lamp holder 19 that is the light source cover is illustrated in FIG. 23. FIG. 23 illustrates an explanatory view illustrating a cross sectional configuration in a direction crossing to the longitudinal direction of a lamp holder 191 according to the fifth modification.

In the lamp holder 191 of this modification, a portion of the sloped cover 26 closer to the opening 19a, that is an urging portion 196 that comes in contact with the cold cathode tube 17 and urges the cold cathode tube toward the placing surface 153a is configured to be accordion-folded and elastically deformable. With the lamp holder 191 provided with such an urging member 196, it is prevented that the lamp holder 191 excessively urges the cold cathode tubes 17 and damages or breaks them. Namely, the urging member 196 that is configured to be accordion-folded to be elastically deformed eases a urging force and ensures appropriate contact between the cold cathode tube 17 and the placing surface 153a.

[Sixth Modification]

Another modification of the relay terminal 152 is illustrated in FIG. 24. FIG. 24 is an explanatory view illustrating a connecting relation between the cold cathode tube 17 and a relay terminal 452 according to the sixth modification.

The relay terminal 452 illustrated in FIG. 24 is wholly made of conductive rubber and configured to include a base 453 formed in a chip or a rectangular shape and walls (light source movement restricting member) 455, 458 provided at a front end and a rear end of the base 453 respectively and legs 457 provided on a rear surface of the base 453. In such a case, since the relay terminal 452 is wholly made of conductive rubber, elasticity is applied to the relay terminal 452. This elasticity ensures reliable contact between the ferrule 136 and the placing surface 453a even if a slight position gap (relative movement) is caused between the two components. Accordingly, the reliable conductivity is ensured. Similar to the second modification, the walls 455, 458 restrict the axial movement of the cold cathode tube 17 in the state in that the cold cathode tube 17 is placed on the placing surface 453a.

[Seventh Modification]

A modification of the cold cathode tube 17 is illustrated in FIG. 25. A cold cathode tube 17a includes a glass tube 40, outer leads 42 and a ferrules 50. Each outer lead 42 has an elongated shape and extends from either ends of the glass tube 40 linearly and concentrically with the glass tube 40. The ferrules 50 are attached to the ends of the glass tube 40.

Each ferrule 50 is formed by bending or hammering a metal plate (e.g., copper alloy plate) punched in a predetermined shape, and includes a body 51 and a conductive piece 57. The body 51 has an overall cylindrical shape and is attached to the periphery of the glass tube 40. The conductive piece 57 extends from an edge of the body 51. It elastically contacts the periphery of the outer lead 42 and is fixed by welding. Namely, ferrules for the cold cathode tube 17a may be configured such that outer leads are electrically connected via the conductive pieces 57 instead of drum-shaped portions.

The ferrules may be configured as illustrated in FIG. 26. The drum-shaped portions 142 of the ferrules 136 illustrated in FIGS. 11 and 12 may be modified to connecting portions 142a having a U-shape. When the glass tube 134 is fitted in the ferrules 136, the U-shaped connecting portions 142a are bent along the outer leads 135 (see FIG. 11) and thus the outer leads 135 can be electrically connected with the connecting portions 142a. This modification, that is, the connecting portions 142 are formed in a U-shape by bending, provides better electrical connection between the ferrules and the outer leads 135.

[Eighth Modification]

The power supply board 170, the balance coils 56 and the relay terminals 152 can be connected as illustrated in FIG. 19. The relay terminals 152 are connected to the secondary sides of the balance coils 56. The balance coils 56 are arranged such that the primary sides of the balance coils 56 are connected in series. This configuration also makes the amount of current supplied to each relay terminal 152 (i.e., each cold cathode tube 17) constant. It also allows the connection between the power supply board 170 and the base 151 that collectively includes the relay terminals 152 and the balance coils 56 with a single line (harness) 160.

The balance coils 56 may be arranged in a tree structure as illustrated in FIG. 28. In FIG. 28, sixteen cold cathode tubes 17 are provided and fifteen balance coils 56 are disposed on one side each. This configuration also makes the amount of current supplied to each relay terminal 152 (i.e., each cold cathode tube 17) constant. It also allows the connection between the power supply board 170 and the base 151 that collectively includes the clip terminals 152 and the balance coils 56 with a single line 160 (branched into two ends of the cold cathode tubes 17 in FIG. 28).

A detection circuit 175 illustrated in FIG. 31 may be provided as an open circuit detection circuit. The detection circuit 175 includes a fail-safe circuit that disable the operation when an unlit cold cathode tube 17 is detected, that is, the circuit is open. It sends feedback indicating an output current of the balance coil 56b on the secondary side. In FIG. 31, the detection circuit 175 detects a current drawn out from a loop circuit on the secondary side of the balance coils 56 off the substrate 151. The detected current is fed back to the power supply board 170 and if an input voltage continues to rise in a condition that the detected current is very small, an open circuit is determined. Then, the supply of the driving power is stopped. In this embodiment, the balance coils 56 are used as balancing components. If capacitors are used as the balancing components, the open circuit detection is required for each capacitor and thus comprehensive detection of an open circuit is difficult to carry out. Therefore, the open circuit detection circuit using the balance coils 56 as in this embodiment is especially effective and a low-cost and safe configuration can be provided.

[Ninth Modification]

To obtain insulation between the chassis 14 and the base 151, an insulation plate (insulation member) 61 may be provided between the chassis 14 and the base 151 as illustrated in FIG. 29. As illustrated in FIG. 30, an opening 62 may be provided in an area of the chassis 14 that overlaps the base 151. Alternatively, the chassis 14 may be made of resin material.

[Tenth Modification]

The power supply board 170 may be arranged as follows.

The power supply board 170 in FIG. 33 is arranged in the central area of the rear surface of the chassis 14. As in the above embodiment, only a single power supply line (harness) 160 is required to supply power using the balance coils 56. Therefore, a leak current is easily controlled and thus the power supply board 170 can be arranged in the central area of the chassis 14. As a result, the liquid crystal display device 10 using the backlight device 12 can be even thinner and this adds higher values to it.

As illustrated in FIG. 34, the power supply board 170 may include a light source driving circuit 170a for driving the cold cathode tubes 17 and a panel driving circuit 170b for driving the liquid crystal panel 11. With this configuration, a primary power is collectively supplied by an AC power source 179. As in the above embodiment, only a single power supply line (harness) 160 is required to supply power using the balance coils 56. Therefore, a light source driving circuit 170a for driving the cold cathode tubes 17 and a panel driving circuit 170b for driving the liquid crystal panel 11 can be provided on the same power supply board 170. With this configuration, a primary power is collectively supplied to the power supply board 170 by an AC power source 179.

As illustrated in FIG. 35, an external information input and output means 178 such as a disk drive may be arranged in an empty space of the chassis 14 in which the power supply boards 170 are arranged. To supply power using the balance coils 56, only a single power supply line (harness) 160 is required and thus the power supply board 170 can be reduced in size. Therefore, the power supply board 170 can be arranged in a part of the chassis along one side (short side) and the external information input and output means 178 such as a disk drive can be arranged in another area. Namely, the space is effectively used.

[Eleventh Modification]

A capacitor may be used for the balance coils 56 to form the balancing components. FIG. 36 is an explanatory view illustrating a configuration in which capacitors 56z are used for the balancing components. The capacitor 56z enables parallel drive, and this enables only a single power supply line (harness) 160 to be required to connect the power supply board 170 and the power relay board 150.

As illustrated in FIG. 37, for example, the capacitor 56z includes a dielectric layer (dielectric portion) 100 that is provided between a common terminal 110 provided on the base 151 and each relay terminal 152. In this case, the equipotential common terminal 110 is provided to supply driving power from one power source 170 to each relay terminal 152 and the driving power is supplied from the common terminal 110 to each relay terminal 152 via the dielectric layer 100. The common terminal 110 is formed of a conductive thin layer such as an aluminum layer and the like and the dielectric layer 100 is formed of a thin layer made of an insulating material such as ceramics and the like. The dielectric layer 100 is also common to the relay terminals and it spreads over all of the relay terminals 152.

The capacitor 56z is formed of the dielectric layer 100 disposed between the relay terminals 152 and the common terminal 110. The capacitors 56z controls (restricts) the driving power supplied to each cold cathode tube 17 to a predetermined voltage value. Due to the capacitor 56z thus formed, the cold cathode tubes 17 form a system capable of being driven in parallel. The drive therefore can be achieved by use of a common inverter circuit component as a power source.

As illustrated in FIG. 38, the capacitive coupling between the relay terminals 152 and the common terminal 111 can be achieved by mounting chip capacitors (dielectric elements) 201 as a dielectric portion on the circuit board (paper phenol substrate) 200. In this case, the relay terminals 152 are mounted on the circuit board 200, and the common terminal 111 is electrically connected to each relay terminal 152 via the corresponding chip capacitor 201. Namely, the chip capacitors 201 are mounted on the circuit board 200, one for each of the relay terminals 152.

As illustrated in FIG. 39, the electrical connection between each relay terminal 152 and the common terminal 110a can be formed by use of a circuit board (a glass-epoxy substrate) 100a as a dielectric portion. In this case, the relay terminals 152 and first-capacity terminals 180a equipotential to the respective relay terminals 152 are formed on an upper surface (a first surface) of the circuit board 100a, as shown also in FIG. 40. Second-capacity terminals 110b arranged on the opposite side of the circuit board 100a from the first-capacity terminals 180a, and the common terminal (a common wiring line) 110a equipotential to the second-capacity terminals 110b are also formed on a lower surface (a second surface) of the circuit board 100a, as illustrated in FIG. 41. On the rear surface of the circuit board, the common terminal 110a is electrically connected to the terminal of the power supply board 170.

As shown in FIG. 42, the electrical connection between each relay terminal 152 and the common terminal 110a can be formed by use of a circuit board (a glass-epoxy substrate) 100a as a dielectric portion. In this case, the relay terminals 152, third-capacity terminals 110c disconnected from the relay terminals 152, and the common terminal (a common wiring line) 110a equipotential to the third-capacity terminals 110c are formed on an upper surface (a first surface) of the circuit board 100a, as illustrated in FIG. 42. On the rear surface of the circuit board 100a, the common terminal 110a is electrically connected to the terminal of the power supply board 170. On the other hand, the lead wires (connecting terminal portions) 180m of the relay terminals 152 penetrating the circuit board 100a from the upper surface side, and fourth-capacity terminals 180n connected to the lead wires 180m so as to be equipotential to the respective relay terminals 152, are formed on a lower surface (a second surface) of the circuit board 100a, as illustrated in FIG. 44. Thus, the parallel coupling can be readily achieved by forming a wiring pattern on the circuit board 100a so that the capacitors are provided.

The display panel 11 of the liquid crystal display device 10 may include switching components other than TFTs. For example, MIMs (Metal Insulator Metal) or other types of switching components can be used. The display device of the present invention is not limited to the liquid crystal display device and various kinds of display device including lighting devices provided behind display panels can be used.

1. A lighting device comprising:
a light source;
a power source configured to supply driving power to the light source; and
a relay terminal configured to electrically connect the light source to the power source, wherein:
the light source includes an electrical terminal configured to receive the supplied driving power;
the relay terminal has a placing surface on which the terminal is placed, and the driving power is supplied to the light source via the placing surface on which the terminal is placed; and
an urging member is provided independently from the relay terminal so as to urge the light source toward the placing surface of the relay terminal.

2. The lighting device according to claim 1, wherein:
the relay terminal includes a conductive elastic member on the placing surface; and
the elastic member is disposed between the placing surface and the electrical terminal in an elastically deformed state with the terminal being placed on the placing surface.

3. The lighting device according to claim 1, further comprising a light source cover covering an end of the light source,
wherein the light source cover urges the light source toward the placing surface as said urging member.

4. The lighting device according to claim 3, wherein:
the light source cover includes a buffer member; and
the buffer member is disposed between the light source cover and the light source with the light source cover covering the light source.

5. The lighting device according to claim 3, wherein:
the light source cover includes an urging portion that is in contact with the light source and urge the light source toward the placing surface; and
the urging portion has an accordion-fold structure so as to be elastically deformable.

6. The lighting device according to claim 1, further comprising a light source movement restricting member that restricts movement of the light source along an axial direction of the light source with the electrical terminal being placed on the placing surface.

7. The lighting device according to claim 6, wherein the light source movement restricting member forms a wall extending upwardly from the placing surface at an end of the relay terminal.

8. The lighting device according to claim 1, wherein:
the light source is a tubular light source;
the electrical terminal is formed in a tubular shape corresponding to a shape of the light source; and
the relay terminal includes an arc-shaped receiving member configured to receive a lower portion of the electrical terminal that is placed on the placing surface is.

9. The lighting device according to claim 8, wherein the arc-shaped receiving member has a cross section in a direction crossing to the axial direction of the tubular light source equal to or smaller than a semi-circular shape.

10. The lighting device according to claim 1, wherein the relay terminal is formed of conductive rubber.

11. The lighting device according to claim 1, wherein the light source includes a linear glass tube, and a ferrule configured to surround an end of the glass tube and function as the electrical terminal.

12. The lighting device according to claim 1, wherein:
a plurality of light sources are provided;
the relay terminal is provided for each of the plurality of light sources; and
a balancing component is provided between the relay terminal and the power source so as to control a current amount of the driving power supplied to each of the relay terminals.

13. The lighting device according to claim 12, wherein the relay terminals are provided on a base and the balancing components are provided on the base.

14. The lighting device according to claim 12, wherein:
the balancing components are provided one for each of the relay terminals; and
the balancing components are connected to the power source in parallel.

15. The lighting device according to claim 12, wherein a number of power supply paths connecting the balancing components to the power source is smaller than a number of the light sources.

16. The lighting device according to claim 12, wherein the balancing components are connected to the power source via a single power supply path.

17. The lighting device according to claim 15, further comprising a chassis accommodating the light sources, wherein:
the light sources, the relay terminals and the balancing components are provided inside the chassis;
the power source is provided outside the chassis; and
the power supply path is routed from the balancing components provided inside the chassis to the power source provided outside the chassis.

18. The lighting device according to claim 17, wherein:
the relay terminals are provided on a base on which the balancing components are provided; and
an insulating material is disposed between the chassis and the base.

19. The lighting device according to claim 17, wherein the relay terminals are provided on a base on which the balancing components are provided; and
the chassis has an opening in an area that overlaps the base.

20. The lighting device according to claim 12, wherein the balancing components are balance coils.

21. The lighting device according to claim 20, wherein:
the balance coils include primary coils and secondary coils; and
the primary coils are connected to the relay terminals and the secondary coils are connected with each other in series.

22. The lighting device according to claim 12, wherein the balancing components are capacitors.

23. A display device comprising:
a lighting device according to claim 1; and
a display panel configured to display using light from the lighting device.

24. The display device according to claim 23, wherein the display panel is a liquid crystal panel using liquid crystal.

25. A television receiver comprising a display device according to claim 23.
